(19) United States
(12) Patent Application Publication
(10) Pub. No.: US 2026/0218009 A1
(43) Pub. Date: Jul. 30, 2026

(54) WATER REPELLENT OIL REPELLENT COMPOSITION, AND WATER REPELLENT OIL REPELLENT FIBER PRODUCT AND METHOD FOR PRODUCING SAME

(71) Applicant: NICCA CHEMICAL CO., LTD., Fukui (JP)

(72) Inventors: Keiichiro SADA, Fukui (JP); Yoshie MINAMIJIMA, Fukui (JP); Kimiyuki SUESADA, Fukui (JP); Kousuke MAEDA, Fukui (JP)

(73) Assignee: NICCA CHEMICAL CO., LTD., Fukui (JP)

(21) Appl. No.: 19/143,804

(22) PCT Filed: Dec. 5, 2023
(86) PCT No.: PCT/JP2023/043432

§ 371 Date: Jun. 26, 2025

(30) Foreign Application Priority Data
Dec. 28, 2022 (JP) 2022-211977

(51) Int. Cl. C09D 183/08; C08K 5/29; C09D 7/63

(52) U.S. Cl. CPC C09D 183/08; C08K 5/29; C09D 7/63

(57) ABSTRACT

The present invention provides a water repellent oil repellent composition which has excellent processing stability and excellent product stability (more specifically, long-term storage stability), while using a silicone compound that has excellent water repellent oil repellent properties; and a water repellent oil repellent fiber product, and a method for producing the water repellent oil repellent fiber product. One mode of the present invention provides a water repellent oil repellent composition which contains a silicone resin, an organic solvent, an emulsifying agent and an aqueous medium, wherein more than 10 mL of water is necessary for dissolving 1 g of the organic solvent at 20° C.

### FIELD

The present invention relates to a water-repellent and oil-repellent composition, to a water-repellent and oil-repellent fiber product, and to a method for producing it.

### BACKGROUND

In the prior art there are known fluorine-based water-repellent and oil-repellent agents that have fluorine groups, as well as fiber products imparted with water and oil repellency on the surface by treatment with such fluorine-based water-repellent and oil-repellent agents. Such fluorine-based water-repellent and oil-repellent agents are generally produced by homopolymerization or copolymerization of monomers with fluoroalkyl groups. Fiber products that have been treated with fluorine-based water-repellent and oil-repellent agents exhibit excellent water and oil repellency, but because monomers with fluoroalkyl groups are poorly degradable they are problematic from an environmental standpoint.

Research has therefore been conducted recently on non-fluorine-based water-repellent agents, which do not contain fluorine. PTL 1, for example, describes a water-repellent agent comprising a specific non-fluorine-based polymer that includes, as a monomer unit, a (meth)acrylic acid ester with 12 or more carbon atoms in the ester portion. Also, PTL 2 describes a water-repellent composition for fibers, comprising component (A) (which is one or more selected from among a urethane compound (A1) having at least one hydrocarbon of 12 or more carbon atoms in the molecule, an acrylic resin (A2) having at least one hydrocarbon of 12 or more carbon atoms in the molecule, and a reactive silicone (A3)), a silicone resin (B) and water, wherein the urethane compound (A1) and acrylic resin (A2) have at least one hydrocarbon atom of 12 or more carbon atoms in the molecule, the units composing the silicone resin (B) are one or more selected from among M units represented by R₃SiO_{1/2}, Q units represented by SiO_{4/2} and T units represented by RSiO_{3/2} (excluding cases with only M units and Q units), and R represents a straight-chain or branched monovalent alkyl group having 1 to 18 carbon atoms.

### CITATION LIST

### Patent Literature

[PTL 1] Japanese Unexamined Patent Publication No. 2006-328624
[PTL 2] Japanese Unexamined Patent Publication No. 2019-173185

### SUMMARY

### Technical Problem

Silicone-based compounds are useful as water-repellent and oil-repellent components from the viewpoint of being non-fluorine-based and having excellent water and oil repellency. The technique described in PTL 2 provides a water-repellent composition for fibers that exhibits low sliding properties when adhered onto fiber products, by using a specific silicone-based compound as the water-repellent component. Conventional silicone-based water-repellent compositions, however, have had insufficient product stability and processing stability.

It is an object of the present invention to solve the problems described above by providing a water-repellent and oil-repellent composition with excellent product stability (more specifically, long-term storage stability) and processing stability, as well as a water-repellent and oil-repellent fiber product and a method for producing it, all while using a silicone-based compound with excellent water and oil repellency.

### Solution to Problem

Specifically, the present disclosure encompasses the following aspects.
[1]A water-repellent and oil-repellent composition comprising a silicone resin, an organic solvent, an emulsifier and an aqueous medium, wherein the organic solvent is an organic solvent such that the amount of water necessary to dissolve 1 g of organic solvent at 20° C. is greater than 10 mL.
[2] The water-repellent and oil-repellent composition according to [1] above, which further comprises an amino-modified silicone.
[3] The water-repellent and oil-repellent composition according to [1] or [2] above, which further comprises an alkylpolysiloxane.
[4] The water-repellent and oil-repellent composition according to any one of [1] to [3] above, which further comprises a polyfunctional isocyanate.
[5]A water-repellent and oil-repellent fiber product which is a fiber product treated by the water-repellent and oil-repellent composition according to any one of [1] to [4] above.
[6]A method for producing a water-repellent and oil-repellent fiber product, comprising a step of treating a fiber product with a treatment solution containing the water-repellent and oil-repellent composition according to any one of [1] to [4] above.

### Advantageous Effects of Invention

According to one aspect of the invention it is possible to provide a water-repellent and oil-repellent composition with excellent product stability (more specifically, long-term storage stability) and processing stability, as well as a water-repellent and oil-repellent fiber product and a method for producing it, all while using a silicone-based compound with excellent water and oil repellency.

### BRIEF DESCRIPTION OF DRAWINGS

FIG. 1 is a graph showing evaluation results for the processing stability of a water-repellent and oil-repellent composition.

### DESCRIPTION OF EMBODIMENTS

A preferred embodiment of the invention (hereunder referred to as “the embodiment”) will now be explained in detail. However, it is to be understood that the invention is not limited to the embodiment.

<Water-Repellent and Oil-Repellent Composition>

The water-repellent and oil-repellent composition of the embodiment comprises a silicone resin, an organic solvent, an emulsifier and an aqueous medium, wherein the organic solvent is an organic solvent such that the amount of water necessary to dissolve 1 g of organic solvent at 20° C. is greater than 10 mL. The water-repellent and oil-repellent composition of the embodiment has excellent water and oil repellency and satisfactory product stability and processing stability. According to one aspect, the water-repellent and oil-repellent composition of the embodiment also has satisfactory seam sliding properties.

The organic solvent referred to throughout the present disclosure may be a liquid at 25° C.

Preferred examples for each component will now be explained.

<Silicone Resin>According to one aspect, the silicone resin includes MQ, MDQ, MT, MTQ, MDT or MDTQ as a constituent component. The silicone resin is preferably solid at 25° C., and is preferably an organopolysiloxane with a three-dimensional structure. Also, the silicone resin has a hardness of preferably 20 or higher and more preferably 60 or higher as measured using a type A Durometer according to the hardness test of JIS K 6249:2003 13. Here, M, D, T and Q represent (R″)₃SiO_{0.5} units, (R″)₂SiO units, R″SiO_{1.5} units and SiO₂ units, respectively. According to one aspect, R″ is a monovalent aliphatic hydrocarbon group having 1 to 10 carbon atoms or a monovalent aromatic hydrocarbon group having 6 to 15 carbon atoms.

A silicone resin here is generally known as a MQ resin, MT resin or MDT resin, with some having sections represented by MDQ, MTQ or MDTQ.

Silicone resins can also be obtained as solutions dissolved in alkylpolysiloxanes or appropriate solvents other than alkylpolysiloxanes. Examples of solvents other than alkylpolysiloxanes include n-hexane, isopropyl alcohol, methylene chloride, 1,1,1-trichloroethane, and mixtures of these solvents. An alkylpolysiloxane used as the solvent may constitute the alkylpolysiloxane described below to be included in the water-repellent and oil-repellent composition of the embodiment.

Examples of solutions obtained by dissolving silicone resins in alkylpolysiloxanes include KF7312J (trimethylsilyl group-containing polysiloxane:decamethylcyclopentasiloxane=50:50 mixture), KF7312F (trimethylsilyl group-containing polysiloxane:octamethylcyclotetrasiloxane=50:50 mixture), KF9021L (trimethylsilyl group-containing polysiloxane:low viscosity methylpolysiloxane=50:50 mixture) and KF7312L (trimethylsilyl group-containing polysiloxane:low viscosity methylpolysiloxane=50:50 mixture), available from Shin-Etsu Chemical Co., Ltd.

Examples of silicone resins alone include MQ-1600 Solid Resin (trimethylsilyl group-containing polysiloxane) and MQ-1640 Flake Resin (trimethylsilyl group-containing polysiloxane and polypropylsilsesquioxane) commercially available by Dow Corning Toray Co., Ltd. The commercial product comprises a trimethylsilyl group-containing polysiloxane, and comprises MQ, MDQ, MT, MTQ, MDT or MDTQ.

### <Organic Solvent>

The water-repellent and oil-repellent composition of the embodiment comprises an organic solvent wherein the amount of water necessary to dissolve 1 g of organic solvent at 20° C. is greater than 10 mL. According to one aspect, the amount of water necessary to dissolve 1 g of the organic solvent is greater than 30 mL, preferably greater than 100 mL and more preferably greater than 1000 mL. Such an organic solvent contributes to formation of an emulsified dispersion in which the silicone resin is stably emulsified and dispersed, and thus contributes to formation of a water-repellent and oil-repellent composition with excellent product stability and processing stability. For the purpose of the present disclosure, “emulsified dispersion” means that a liquid is present in an emulsified state and/or a solid is present in a dispersed state in a liquid medium. According to one aspect, an organic solvent such that the amount of water necessary to dissolve 1 g of organic solvent at 20° C. is greater than 10 mL contributes to improved water and oil repellency by improving the film formability of the silicone-based compound as the water-repellent and oil-repellent component on the fibers. The amount of water necessary to dissolve 1 g of the organic solvent is the value measured by the method described under [Examples] of the present disclosure, according to JIS K8001:2017.

While it is not our intention to be limited to any particular theory, it is conjectured that when a silicone resin is emulsified and dispersed in a water-containing medium to form an emulsified dispersion or water-repellent and oil-repellent composition, the organic solvent of the embodiment promotes formation of an O/W-type emulsified dispersion of the silicone resin, thus contributing to improved emulsified dispersion stability of the silicone resin in the water-containing medium.

An organic solvent such that the amount of water necessary to dissolve 1 g of organic solvent at 20° C. is greater than 10 mL preferably has a structure composed of carbon and hydrogen (that is, a hydrocarbon structure) in the molecule, from the viewpoint of obtaining a satisfactory improving effect on the emulsified dispersion stability of the silicone resin. From this viewpoint, preferred organic solvents include esters (specific examples including 2,2,4-trimethyl-1,3-pentanediol monoisobutyrate, 2,2,4-trimethyl-1,3-pentanediol diisobutyrate, ethyl acetate, butyl acetate and butyl glycol acetate), ketones (specific examples including methyl isobutyl ketone), ethers (specific examples including dibutyldiglycol, diethyleneglycol mono-2-ethylhexyl ether, ethyleneglycol monohexyl ether, diethyleneglycol monohexyl ether, ethyleneglycol mono-2-ethylhexyl ether, dipropyleneglycol monopropyl ether and dipropyleneglycol monobutyl ether), alcohols (specific examples including 1-butanol, 1-pentanol and isooctanol), aromatic solvents (specific examples including toluene, o-xylene, m-xylene, p-xylene and mesitylene), and petroleum-based solvents (specific examples including isoparaffins, mineral oils, mineral spirits, and synthetic oils such as poly α-olefins), and such organic solvents may be used as single types alone or combinations of two or more types.

The number of carbon atoms of an isoparaffin is preferably 4 or greater and more preferably 9 to 20.

Such isoparaffins include IPSolvent IP-2028 (isoparaffin of 10 to 16 carbon atoms, product of Idemitsu Kosan Co., Ltd.).

Mineral oils include mineral oils with kinematic viscosities of 50 mm²/s or lower at 30° C., and more specifically normal undecane, normal dodecane, normal tridecane, normal tetradecane and paraffins. The kinematic viscosity is the value measured by the method of JIS K 2283:2000. The number of carbon atoms of the paraffin may be 10 to 16, for example. Such mineral oils may be used alone, or in combinations of two or more. When two or more different types are used in combination, they are preferably mutually compatible. The mineral oil may be a commercial product, examples of which include cactus normal paraffin N-12D, cactus normal paraffin YHNP and cactus normal paraffin N-14 (all available from ENEOS).

Preferred mineral spirits are those with boiling points of 130 to 230° C.

The amount of organic solvent in the water-repellent and oil-repellent composition such that the amount of water necessary to dissolve 1 g of organic solvent at 20° C. is greater than 10 ml, is preferably 10 to 500 parts by mass, more preferably 20 to 400 parts by mass and even more preferably 30 to 300 parts by mass with respect to 100 parts by mass of the silicone resin. The amount of organic solvent is preferably within this range from the viewpoint of continuous product stability and processing stability of the water-repellent and oil-repellent composition.

### <Emulsifier>

According to one aspect, the emulsifier may be a surfactant. The surfactant may also include one or more surfactants selected from among cationic surfactants, anionic surfactants, nonionic surfactants and amphoteric surfactants. From the viewpoint of satisfactorily obtaining emulsification stability and water and oil repellency for the water-repellent and oil-repellent composition, the surfactant is preferably a nonionic surfactant and/or a cationic surfactant, and more preferably a combination of a nonionic surfactant and a cationic surfactant. According to one aspect, the surfactant preferably does not contain an anionic surfactant.

### [Nonionic Surfactant]

Nonionic surfactants include ethers, esters, ester ethers, alkanolamides, polyhydric alcohols and amine oxides.

Ethers include compounds with oxyalkylene groups (preferably polyoxyethylene groups).

Esters include esters of alcohols and fatty acids.

Ester ethers include compounds obtained by adding an alkylene oxide such as ethylene oxide to an ester of an alcohol and a fatty acid.

In the ester or ester ether, the alcohol may be a monovalent to hexavalent and preferably bivalent to pentavalent alcohol of 1 to 50 and preferably 3 to 30 carbon atoms. The alcohol is preferably an aliphatic alcohol. The fatty acid in the ester or ester ether may be a saturated or unsaturated fatty acid of 2 to 50 carbon atoms and preferably 5 to 30 carbon atoms.

The alkanolamide may be formed from a fatty acid and an alkanolamine. The alkanolamide may be a monoalkanolamide or dialkanolamide, for example. The fatty acid may be a saturated or unsaturated fatty acid of 2 to 50 carbon atoms and preferably 5 to 30 carbon atoms. The alkanolamine may be an alkanol of 2 to 50 and preferably 5 to 30 carbon atoms, having 1 to 3 amino groups and 1 to 5 hydroxyl groups, for example.

Polyhydric alcohols include bivalent to pentavalent alcohols of 15 to 30 carbon atoms.

An amine oxide may be an oxide of an amine. The amine may be a secondary amine or a tertiary amine. The number of carbon atoms in the amine oxide is preferably 5 to 50.

The nonionic surfactant preferably has an oxyalkylene group (preferably an oxyethylene group). The number of carbon atoms of the oxyalkylene group is preferably 2 to 10. The number of oxyalkylene units in the molecule of the nonionic surfactant is preferably 2 to 100.

More specific preferred examples of nonionic surfactants include alkylene oxide addition products of straight-chain and/or branched saturated and/or unsaturated aliphatic groups, polyalkylene glycol esters of straight-chain and/or branched saturated and/or unsaturated fatty acids, random or block copolymers of polyoxyethylene (POE)/polyoxypropylene (POP), and alkylene oxide addition products of acetylene glycol. The structure of the alkylene oxide-added portion and polyalkylene glycol portion is preferably polyoxyethylene (POE), polyoxypropylene (POP) or a random or block copolymer of POE/POP

The nonionic surfactant preferably does not include an aromatic structure from the viewpoint of environmental load, including biodegradability and environmental hormone effects.

According to a preferred aspect, the nonionic surfactant is a compound represented by the following formula (1):

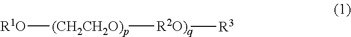

[where
R¹ represents an alkyl group having 1 to 22 carbon atoms, an alkenyl group having 2 to 22 carbon atoms or an acyl group having 2 to 22 carbon atoms,
R² represents an alkylene group having 3 or more carbon atoms, each independently, when multiple groups are present,
R³ represents a hydrogen atom, an alkyl group having 1 to 22 carbon atoms or an alkenyl group having 2 to 22 carbon atoms,
p is a number of 2 or greater, and
q is a number of 0, 1 or greater.

The number of carbon atoms of R¹ is preferably 8 to 20 and more preferably 10 to 18. R¹ is preferably a lauryl, tridecyl or oleyl group.

R² is preferably an alkylene group having 3 to 10 carbon atoms, and more preferably a propylene or butylene group.

The letter p is preferably 3 or greater or 5 or greater, and preferably 200 or less.

The letter q is preferably 2 or greater or 5 or greater, and preferably 200 or less. According to one aspect, —(R²O)_{q}— is a polyoxyalkylene chain.

The nonionic surfactant may be a polyoxyethylene alkylenealkyl ether having a hydrophilic polyoxyethylene site and a hydrophobic oxyalkylene site (for example, a polyoxyalkylene chain). The hydrophobic oxyalkylene site may be an oxypropylene site or oxybutylene site, and is preferably an oxypropylene site.

According to a preferred aspect, the nonionic surfactant is a compound represented by the following formula (2):

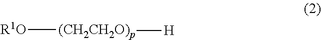

[wherein R¹ and p are the same as defined in formula (1)].

According to a preferred aspect, the nonionic surfactant is a compound represented by any among the following formula group (3):

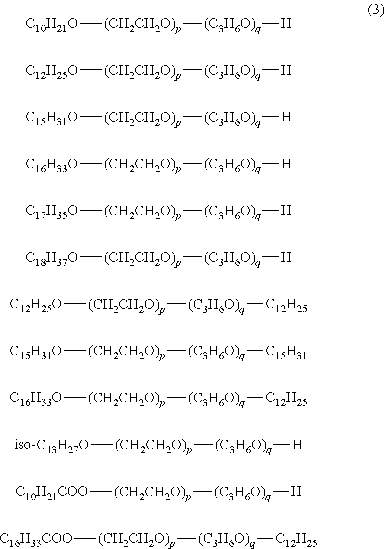

[where p and q are the same as defined in formula (1)].

More specific examples of nonionic surfactants include condensation products of ethylene oxide with hexylphenol, isooctamethylphenol, hexadecanol, oleic acid, alkane(C₁₂-C₁₆)thiols, sorbitan mono fatty acids (C₇-C₁₉) or alkyl(C₁₂-C₁₈)amines.

When the nonionic surfactant has a polyoxyethylene block, the mass ratio of the polyoxyethylene block in the molecule may be 5 to 80 mass %, 30 to 75 mass % or 40 to 70 mass %, according to one aspect.

The nonionic surfactant may be a single type or a combination of two or more types, but it is preferably a combination of two or more types. For a combination of two or more different types, preferably at least one nonionic surfactant is a compound wherein the R¹ and/or R³ groups in formula (1) or (2) or the alkyl groups in formula (3) are branched alkyl groups such as isotridecyl groups (hereinafter referred to as “branched compounds”). The amount of branched compounds is preferably 5 to 100 mass %, 8 to 50 mass % or 10 to 40 mass %, with respect to 100 mass % as the total of the potentially two or more nonionic surfactants. In combinations of two or more nonionic surfactants, at least one nonionic surfactant may be a compound other than the aforementioned branched compound. Such compounds include compounds wherein the R¹ group and/or R³ group in formula (1) or (2) or the alkyl group in formula (3) is a saturated or unsaturated straight-chain alkyl group, such as a lauryl group.

Particularly preferred examples of nonionic surfactants include polyoxyethylene alkyl ethers, polyoxyethylene alkylphenyl ethers, polyoxyethylene fatty acid esters, sorbitan fatty acid esters, polyoxyethylene sorbitan fatty acid esters, polyoxyethylene sorbitol fatty acid esters, glycerin fatty acid esters, polyoxyethylene glycerin fatty acid esters, polyglycerin fatty acid esters, sucrose fatty acid esters, polyoxyethylene alkylamines, polyoxyethylene fatty acid amides, fatty acid alkylol amides, alkylalkanolamides, acetylene alcohols (such as acetylene glycol), acetylene glycol oxyethylene addition products, and polyethylene glycol-polypropylene glycol block copolymers. From the viewpoint of reducing the dynamic surface tension of the water-repellent and oil-repellent composition to facilitate permeation of the composition into the fiber product, the nonionic surfactant is preferably an acetylene alcohol (for example, acetylene glycol) or an oxyethylene addition product of an acetylene alcohol.

According to a preferred aspect, the nonionic surfactant is an alcohol with an unsaturated triple bond, or an alkylene oxide addition product of the alcohol (these will hereunder be collectively referred to as “triple bonded alcohol compound”). A triple bonded alcohol compound comprises one or more triple bonds and one or more hydroxyl groups. The alcohol may be a monool or polyol. The alkylene oxide addition structure preferably includes a polyoxyalkylene addition structure, such as a polyoxyethylene addition structure or polyoxypropylene addition structure, or a random or block addition structure of polyoxyethylene and polyoxypropylene.

The triple bonded alcohol compound may be a compound represented by the following formula (4) or (5):

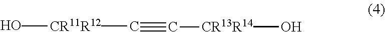

[where R¹¹, R¹², R¹³ and R¹⁴ each independently represent a hydrogen atom or an alkyl group having 1 to 30 carbon atoms],

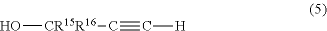

[where R¹⁵ and R¹⁶ each independently represent a hydrogen atom or an alkyl group having 1 to 30 carbon atoms],
or an alkylene oxide addition product of the same. The number of carbon atoms of the alkylene oxide is preferably 1 to 20 or 2 to 5, and preferred examples of alkylene oxides are ethylene oxide and propylene oxide. The number of added alkylene oxides is preferably 1 to 50. The alkyl group in formula (4) or (5) is preferably a straight-chain or branched alkyl group having 1 to 12 or 1 to 6 carbon atoms, and more preferably a methyl, ethyl, propyl, butyl or isobutyl group.

Specific examples of triple bonded alcohol compounds include acetylenediol, propargyl alcohol, 2,5-dimethyl-3-hexyne-2,5-diol, 3,6-dimethyl-4-octyne-3,6-diol, 2,4,7,9-tetramethyl-5-decyne-4,7-diol, 3,5-dimethyl-1-hexyne-3-ol, 3-methyl-1-butyne-3-ol, 3-methyl-1-penten-3-ol, 3-hexyne-2,5-diol and 2-butyne-1,4-diol, as well as their polyethoxylate and ethylene oxide addition products.

The nonionic surfactant may be either or both a compound with a triple bond and a compound without a triple bond. According to one aspect, in a combination of a compound with a triple bond and a compound without a triple bond, the mass ratio of the compound with a triple bond (for example, an acetylene alcohol compound) and the compound without a triple bond (for example, a nonionic surfactant with an oxyalkylene group), may be 10:90 to 90:10 or 20:80 to 80:20.

According to one aspect, the weight-average molecular weight of the nonionic surfactant may be 300 to 5,000 or 500 to 3,000. The weight-average molecular weight is the value measured using gel permeation chromatography (GPC) in terms of standard polyethylene glycol

### [Cationic Surfactant]

Cationic surfactants include amines, amine salts, quaternary ammonium salts, imidazolines and imidazolinium salts. According to one aspect, the cationic surfactant does not have an amide group. Preferred examples of cationic surfactants include amine salts, quaternary ammonium salts and oxyethylene-added ammonium salts. Specific examples of cationic surfactants include amine salt-type surfactants such as alkylamine salts, amino alcohol fatty acid derivatives, polyamine fatty acid derivatives and imidazoline, and quaternary ammonium salt-type surfactants such as alkyltrimethyl ammonium salts, dialkyldimethylammonium salts, alkyldimethylbenzylammonium salts, pyridinium salts, alkylisoquinolinium salts and benzethonium chloride.

According to a preferred aspect, the cationic surfactant is a compound represented by the following formula (6):

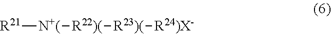

[where R²¹, R²², R²³ and R²⁴ each independently represent a hydrogen atom or a hydrocarbon group having 1 to 50 carbon atoms, and X represents an anionic group] The hydrocarbon groups in the formula may have oxygen atoms, and for example, they may be oxyalkylene groups such as polyoxyalkylene groups. The number of carbon atoms in the alkylene site may be 2 to 5, for example. The hydrocarbon groups as R²¹, R²², R²³ or R²⁴ may be aliphatic or aromatic groups, or a combination of such hydrocarbon groups. Preferably, R²¹, R²², R²³ and R²⁴ are each independently a hydrocarbon group having 1 to 30 carbon atoms.

Specific examples of R²¹, R²², R²³ and R²⁴ include alkyl groups (for example, methyl, butyl, stearyl and palmityl groups), aryl groups (for example, phenyl) and aralkyl groups (for example, benzyl and phenethyl groups).

Specific examples for X include halogens and acids. A halogen may be chlorine, for example. An acid may be an inorganic acid such as hydrochloric acid or an organic acid such as acetic acid (especially a fatty acid).

According to a preferred aspect, the cationic surfactant is a monoalkyltrimethylammonium salt. The number of carbon atoms at the alkyl site may be 4 to 30, for example.

According to a preferred aspect, the cationic surfactant is an ammonium salt, and especially a quaternary ammonium salt. A cationic surfactant may be an ammonium salt represented by the following formula (7):

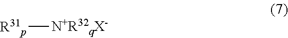

[where
R³¹ represents a straight-chain or branched, saturated or unsaturated aliphatic group having 12 or more carbon atoms, each independently when multiple groups are present,
R³² represents a hydrogen atom or an alkyl, benzyl or polyoxyethylene group having 1 to 4 carbon atoms, each independently when multiple groups are present,
X represents a halogen atom or a fatty acid salt group having 1 to 4 carbon atoms,
p is 1 or 2, and
q is 2 or 3, with the proviso that p+q=4].

The number of carbon atoms of R³¹ is preferably 12 to 50, or 12 to 30.

According to one aspect, the number of repeating oxyethylene units in the polyoxyethylene group as R³² may be 1 to 50, 2 to 50 or 3 to 50, and is preferably 1 or 2.

X is preferably chlorine or bromine.

Specific examples of cationic surfactants include dodecyltrimethylammonium acetate, trimethyltetradecylammonium chloride, hexadecyltrimethylammonium bromide, trimethyloctadecylammonium chloride, (dodecylmethylbenyzl)trimethylammonium chloride, benzyldodecyldimethylammonium chloride, methyldodecyldi(hydropolyoxyethylene)ammonium chloride and benzyldodecyldi(hydropolyoxyethylene)ammonium chloride.

### [Amphoteric Surfactant]

Amphoteric surfactants include alanines, imidazoliniumbetaines, amidebetaines and betaine acetate, and specifically lauryl betaine, stearyl betaine, laurylcarboxymethylhydroxyethyl imidazolinium betaine, betaine lauryldimethylaminoacetate and fatty acid betaine amide propyldimethylaminoacetate.

According to one aspect, the surfactant may be a combination of one or more nonionic surfactants, one or more cationic surfactants, and one or more amphoteric surfactants.

According to one aspect, the amount of cationic surfactant is preferably 15 mass % or greater, more preferably 20 mass % or greater and most preferably 25 mass % or greater, with respect to 100 mass % as the total amount of the surfactant. When a combination of a nonionic surfactant and a cationic surfactant is used, the mass ratio of the nonionic surfactant and cationic surfactant is preferably 85:15 to 20:80 and more preferably 80:20 to 40:60.

The amount of cationic surfactant may be 0.05 to 10 parts by mass, such as 0.1 to 8 parts by mass, with respect to 100 parts by mass of the silicone resin.

The total amount of the emulsifying agent, and especially the surfactant, may be 0.1 to 20 parts by mass, such as 0.2 to 10 parts by mass, with respect to 100 parts by mass of the silicone resin.

The HLB of the nonionic surfactant is preferably 6 to 15, 6.5 to 14, 7 to 13 or 8 to 12, from the viewpoint of product stability of the water-repellent and oil-repellent composition.

Throughout the present disclosure, the term “HLB” is that calculated as Griffin HLB. The term “hydrophilic groups” refers to ethylene oxide groups.

HLB=(hydrophilic group×20)/molecular weight

Nonionic surfactant HLB=(molecular weight of hydrophilic group portion of nonionic surfactant)×20/molecular weight of nonionic surfactant

### <Aqueous Medium>

The water-repellent and oil-repellent composition of the embodiment also comprises an aqueous medium which is different from the organic solvent of the embodiment (an organic solvent wherein the amount of water necessary to dissolve 1 g of organic solvent at 20° C. is greater than 10 mL). According to one aspect, the aqueous medium is an organic solvent in which the amount of water necessary to dissolve 1 g of organic solvent at 20° C. is 10 mL or less, as evaluated by the method described under [Examples] in the present disclosure. According to one aspect, the aqueous medium is an alcohol. An alcohol may be used alone or in combinations of two or more. The alcohol is not particularly restricted, and examples include alcohols of 1 to 6 carbon atoms, among which methanol, ethanol, isopropanol, glycerin, trimethylolpropane, ethylene glycol, diethylene glycol, triethylene glycol, propylene glycol, dipropylene glycol, tripropylene glycol, hexylene glycol, glycerin, butyl glycol, butyldiglycol and Solfit are preferred. Compounds other than alcohols, such as N-methylpyrrolidone, dimethylformamide and dimethyl sulfoxide, may also be used. These organic solvents can be miscible with water, and they may be included in the water-repellent and oil-repellent composition as a mixed solvent with water.

### <Amino-Modified Silicone>

According to one aspect, the water-repellent and oil-repellent composition may further include an amino-modified silicone. An amino-modified silicone is advantageous as a water-repellent component. An amino-modified silicone may be a compound having an organic group containing an amino and/or imino group on the side chain or end of the organopolysiloxane. Examples of such organic groups include organic groups represented by —R—NH₂ and organic groups represented by —R—NH—R′—NH₂. R and R include divalent groups such as ethylene and propylene. All or some of the amino and/or imino groups may be blocked amino and/or imino groups. Blocked amino and/or imino groups are obtained, for example, by treating amino and/or imino groups with a blocking agent. Examples of blocking agents include fatty acids of 2 to 22 carbon atoms, acid anhydrides of fatty acids with 2 to 22 carbon atoms, acid halides of fatty acids with 2 to 22 carbon atoms, and aliphatic monoisocyanates of 1 to 22 carbon atoms. An organic group, for the purpose of the disclosure, is a group having 1 or more carbon atoms.

The functional group equivalent of the amino-modified silicone is preferably 100 to 20,000 g/mol, more preferably 150 to 12,000 g/mol and even more preferably 200 to 4,000 g/mol, from the viewpoint of water-repellency, durable water-repellency, texture and seam sliding properties.

The amino-modified silicone is preferably liquid at 25° C. The kinematic viscosity of the amino-modified silicone at 25° C. is preferably 10 to 100,000 mm²/s, more preferably 10 to 30,000 mm²/s and even more preferably 10 to 5,000 mm²/s. If the kinematic viscosity at 25° C. is 100,000 mm²/s or lower it will tend to be easier to ensure manageability and seam sliding properties. The kinematic viscosity at 25° C. is the value measured by the method described in JIS K 2283:2000 (Ubbelohde viscometer).

The amino-modified silicone used may be a commercial product. Examples of commercial products include KF8005, KF-868, KF-864 and KF-393 (all trade names of Shin-Etsu Chemical Co., Ltd.), XF42-B1989 (Momentive Materials Performance, Inc., Japan), SF-8417 and BY16-853U (both trade names of Dow Corning Toray).

A single type of amino-modified silicone may be used alone, or two or more may be used in combination.

The amino-modified silicone may have all or a portion of the amino and/or imino groups neutralized or unneutralized. Neutralization may be with an organic acid such as lactic acid, acetic acid, propionic acid, maleic acid, oxalic acid, formic acid, methanesulfonic acid or toluenesulfonic acid; or an inorganic acid such as hydrochloric acid, sulfuric acid or nitric acid.

The content of the amino-modified silicone in the water-repellent and oil-repellent composition of the embodiment may be 0.01 to 1 mass % based on the total amount of the water-repellent and oil-repellent composition, when the water-repellent and oil-repellent composition is a treatment bath (for example, a treatment bath for treatment of the fibers). During circulation, the amino-modified silicone content may be 0.1 to 50 mass % or 0.2 to 20 mass %, based on the total amount of the water-repellent and oil-repellent composition.

When the water-repellent and oil-repellent composition of the embodiment includes an amino-modified silicone, the content of the silicone resin may be 50 to 15,000 parts by mass, 100 to 10,000 parts by mass, 150 to 6,000 parts by mass, 500 to 15,000 parts by mass or 900 to 6,000 parts by mass, with respect to 100 parts by mass of the amino-modified silicone content, from the viewpoint of water-repellency, texture and seam sliding properties.

### <Alkylpolysiloxane>

According to one aspect, the water-repellent and oil-repellent composition may further include an alkylpolysiloxane. Alkylpolysiloxanes are advantageous as water-repellent components. An alkylpolysiloxane is a compound wherein the side chains and ends of a straight-chain organopolysiloxane are saturated hydrocarbon groups, or a compound wherein the side chains of a cyclic organopolysiloxane are saturated hydrocarbon groups. Examples of alkylpolysiloxanes include compounds represented by the following general formula (8):

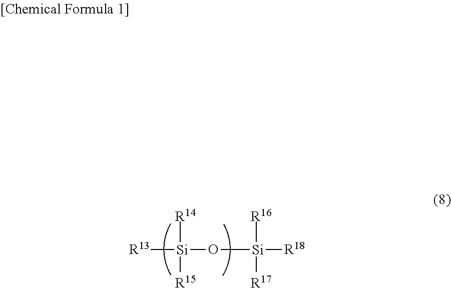

[where R¹³, R¹⁴, R¹⁵, R¹⁶, R¹⁷ and R¹⁸ each independently represent a monovalent saturated hydrocarbon group having 1 to 18 carbon atoms and v represents an integer of 1 or greater], and compounds represented by the following general formula (9):

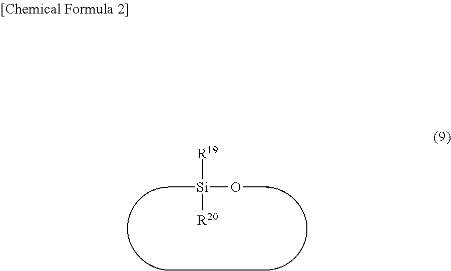

[where R¹⁹ and R²⁰ each independently represent a monovalent saturated hydrocarbon group having 1 to 18 carbon atoms, and w represents an integer of 2 to 20].

In a compound represented by general formula (8) above to be used for this embodiment, R¹³, R¹⁴, R¹⁵, R¹⁶, R¹⁷ and R¹⁸ each independently represent a monovalent saturated hydrocarbon group having 1 to 18 carbon atoms. The number of carbon atoms of the saturated hydrocarbon group is preferably 1 to 10 from the viewpoint of facilitating dissolution of the silicone resin in the compound represented by general formula (8), and from the viewpoint of availability of the compound. The saturated hydrocarbon group may be straight-chain or branched. The saturated hydrocarbon group is preferably straight-chain, and more preferably a straight-chain alkyl group. The saturated hydrocarbon group is preferably a methyl or ethyl group, and more preferably a methyl group. The letter v represents an integer of 1 or greater. The value of v may be appropriately selected so that the kinematic viscosity of the compound represented by general formula (8) is within the range of the kinematic viscosity of the alkylpolysiloxane below, and according to one aspect it may be 0.1 to 100,000 mm²/s.

Examples of compounds represented by general formula (8) include dimethylpolysiloxane and diethylpolysiloxane.

In a compound represented by general formula (9) above to be used for this embodiment, R¹⁹ and R²⁰ each independently represent a monovalent saturated hydrocarbon group having 1 to 18 carbon atoms. The number of carbon atoms of the saturated hydrocarbon group is preferably 1 to 10. If the number of carbon atoms of the saturated hydrocarbon group is within this range, dissolution of the silicone resin in the compound represented by general formula (9) will tend to be easier, and it will tend to be easier to obtain the compound. The saturated hydrocarbon group may be straight-chain or branched. The saturated hydrocarbon group is preferably straight-chain, and more preferably a straight-chain alkyl group. The saturated hydrocarbon group is preferably a methyl or ethyl group, and more preferably a methyl group. The letter w represents an integer of 2 to 20. The value of w is preferably 3 to 10, and more preferably 4 or 5. If w is within this range, the silicone resin in the compound represented by general formula (9) will tend to dissolve more easily, and it will tend to be easier to obtain the compound.

Examples of compounds represented by general formula (9) above include decamethylcyclopentasiloxane and octamethylcyclotetrasiloxane.

An alkylpolysiloxane may be used alone or in combinations of two or more.

The alkylpolysiloxane is preferably liquid at 25° C. The kinematic viscosity of the alkylpolysiloxane at 25° C. is preferably 0.1 to 100,000 mm²/s, more preferably 0.1 to 10,000 mm²/s, even more preferably 0.1 to 1,000 mm²/s, yet more preferably 0, 1 to 500 mm²/s and most preferably 0.1 to 100 mm²/s. If the kinematic viscosity at 25° C. is within this range, the silicone resin will tend to dissolve in the alkylpolysiloxane and it will tend to be easier to ensure manageability. The kinematic viscosity at 25° C. is the value measured by the method described in JIS K 2283:2000 (Ubbelohde viscometer).

The alkylpolysiloxane content in the water-repellent and oil-repellent composition of the embodiment is preferably 500 to 15,000 parts by mass and more preferably 900 to 6,000 parts by mass with respect to 100 parts by mass of the amino-modified silicone, from the viewpoint of water-repellency, texture and seam sliding properties.

In the water-repellent and oil-repellent composition of the embodiment, the weight ratio of the silicone resin and alkylpolysiloxane (silicone resin:alkylpolysiloxane) is preferably 10:90 to 80:20, 20:80 to 60:40 or 20:80 to 10:60, from the viewpoint of water-repellency, feel and seam sliding properties.

### <Polyfunctional Isocyanate>

According to one aspect, the water-repellent and oil-repellent composition may further include a polyfunctional isocyanate as a crosslinking component. The polyfunctional isocyanate is not particularly restricted so long as it is a compound having two or more isocyanate groups in the molecule, and any publicly known polyisocyanate compound may be used. Examples of polyfunctional isocyanates include diisocyanate compounds such as alkylene diisocyanates, aryldiisocyanates and cycloalkyldiisocyanates, and modified polyisocyanate compounds such as dimers, trimers or tetramers of such diisocyanate compounds. The number of carbon atoms for an alkylene diisocyanate is preferably 1 to 12, the number of carbon atoms for an aryl diisocyanate is preferably 6 to 24 and the number of carbon atoms for a cycloalkyl diisocyanate is preferably 3 to 24.

Examples of diisocyanate compounds include 2,4 or 2,6-tolylene diisocyanate, ethylene diisocyanate, propylene diisocyanate, 4,4-diphenylmethane diisocyanate, p-phenylene diisocyanate, tetramethylene diisocyanate, hexamethylene diisocyanate, decamethylene diisocyanate, dodecamethylene diisocyanate, 2,4,4-trimethylhexamethylene-1,6-diisocyanate, phenylene diisocyanate, tolylene or naphthylene diisocyanate, 4,4-methylene-bis(phenylisocyanate), 2,4′-methylene-bis(phenylisocyanate), 3,4′-methylene-bis(phenylisocyanate), 4,4′-ethylene-bis(phenylisocyanate), ω,ω′-diisocyanato-1,3-dimethylbenzene, ω,ω′-diisocyanato-1,4-dimethylcyclohexane, ω,ω′-diisocyanato-1,4-dimethylbenzene, ω,ω′-diisocyanato-1,3-dimethylcyclohexane, 1-methyl-2,4-diisocyanatocyclohexane, 4,4′-methylene-bis(cyclohexylisocyanate), 3-isocyanato-methyl-3,5,5-trimethylcyclohexylisocyanate, acid-diisocyanate dimer, ω,ω′-diisocyanatodiethylbenzene, ω,ω′-diisocyanatodimethyltoluene, ω,ω′-diisocyanatodiethyltoluene, fumaric acid bis(2-isocyanatoethyl) ester, 1,4-bis(2-isocyanate-prop-2-yl)benzene, and 1,3-bis(2-isocyanate-prop-2-yl)benzene.

Examples of triisocyanate compounds include triphenylmethane triisocyanate and tris(isocyanatophenyl)-thiophosphate. Examples of tetraisocyanate compounds include dimethyltriphenylmethane tetraisocyanate.

A modified polyisocyanate compound derived from a diisocyanate compound is not particularly restricted so long as it has two or more isocyanate groups, and examples include polyisocyanates with biuret structures, isocyanurate structures, urethane structures, urethodione structures, allophanate structures and trimer structures, and trimethylolpropane aliphatic isocyanate adducts. Polymeric MDI (MDI=diphenylmethane diisocyanate) may also be used as a polyisocyanate compound. These polyisocyanate compounds may be used alone or in combinations of two or more.

The isocyanate groups of a polyfunctional isocyanate may be the groups themselves, or they may be blocked isocyanate groups blocked with a blocking agent. Blocking agents include pyrazoles such as 3,5-dimethylpyrazole, 3-methylpyrazole, 3,5-dimethyl-4-nitropyrazole, 3,5-dimethyl-4-bromopyrazole and pyrazole; phenols such as phenol, methylphenol, chlorophenol, iso-butylphenol, tert-butylphenol, iso-amylphenol, octylphenol and nonylphenol; lactams such as ε-caprolactam, δ-valerolactam and γ-butyrolactam; active methylene compounds such as dimethyl malonate ester, diethyl malonate ester, acetylacetone, methyl acetoacetate and ethyl acetoacetate; oximes such as formaldoxime, acetaldoxime, acetoneoxime, methyl ethyl ketoneoxime, cyclohexarioneoxime, acetopherioneoxime and benzophenoneoxime; imidazole compounds such as imidazole and 2-methylimidazole; and sodium bisulfite. Pyrazoles and oximes are preferred among these from the viewpoint of durable water-repellency.

A polyfunctional isocyanate used may be a water-dispersible isocyanate that imparts water dispersibility to the polyisocyanate, by introducing a hydrophilic group into the polyisocyanate structure to produce a surfactant effect. In order to promote reaction between the amino group and isocyanate group, a known catalyst such as organic tin or organic zinc may also be used in combination.

The content of the polyfunctional isocyanate in the water-repellent and oil-repellent composition of the embodiment is preferably 1 to 200 parts by mass and more preferably 5 to 100 parts by mass with respect to 100 parts by mass of the amino-modified silicone, from the viewpoint of water-repellency, durable water-repellency, and texture.

### <Additional Water-Repellent Component>

The water-repellent and oil-repellent composition of the embodiment may further include, as additional water-repellent components, one or more of the following: publicly known fluorine-based polymers; or hydrocarbon group-containing compounds such as aliphatic hydrocarbons, aliphatic carboxylic acids and their ester compounds, polyolefins, and poly(meth)acrylic acid esters.

Examples of conventional fluorine-based polymers include NIK Guard S-33 (product of Nicca Chemical Co., Ltd.).

Examples of aliphatic hydrocarbons include paraffinic hydrocarbons and olefinic hydrocarbons. The number of carbon atoms of the aliphatic hydrocarbon is preferably 12 or greater.

The aliphatic carboxylic acid may be either saturated or unsaturated, and the number of carbon atoms is preferably 12 or greater. Ester compounds of such aliphatic carboxylic acids may also be used.

Examples of polyolefins include polyethylene, polypropylene and ethylene-propylene copolymers.

The poly(meth)acrylic acid ester preferably has a hydrocarbon group with 12 or more carbon atoms, bonded via ester bonds. The number of carbon atoms of the hydrocarbon group is also preferably 24 or less. The hydrocarbon groups may be straight-chain or branched, and may be saturated hydrocarbons or unsaturated hydrocarbons, and may also be alicyclic or aromatic cyclic groups. Preferred among these are straight-chain groups, and more preferably straight-chain alkyl groups. The constituent ratio of the acrylic acid ester or methacrylic acid ester monomer in the polymer is preferably 80 to 100 mass % with respect to the total amount of the monomer units composing the polymer. The weight-average molecular weight of the polymer is preferably 30,000 or greater as the value in terms of standard polystyrene, as measured by gel permeation chromatography. A copolymer of an acrylic acid ester and a methacrylic acid ester may also be used.

Examples of such poly(meth)acrylic acid esters (non-fluorine-based polymers) include non-fluorine acrylic polymers containing structural units derived from a (meth)acrylic acid ester monomer (A) represented by general formula (A-1) (hereunder also referred to as “component (A)”).

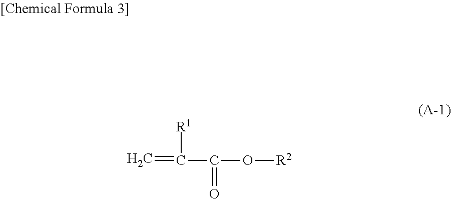

[In formula (A-1), R¹ represents hydrogen, methyl or a halogen group, and R² represents a monovalent hydrocarbon group having 12 or more carbon atoms, which is optionally substituted.]

The (meth)acrylic acid ester monomer (A) represented by general formula (A-1) used for this embodiment has a monovalent hydrocarbon group having 12 or more carbon atoms, which is optionally substituted. The hydrocarbon group may be straight-chain or branched, and may be a saturated hydrocarbon group or unsaturated hydrocarbon group, and may also be an alicyclic or aromatic cyclic group. Preferred among these are straight-chain groups, and more preferably straight-chain alkyl groups. This will result in more excellent water-repellency. When a monovalent hydrocarbon group having 12 or more carbon atoms has a substituent, the substituent may be one or more from among hydroxy, amino, carboxy, epoxy, isocyanate, blocked isocyanates and (meth)acryloyl oxy groups. For this embodiment, R² in general formula (A-1) is preferably an unsubstituted hydrocarbon group.

The number of carbon atoms of the hydrocarbon group is preferably 12 to 40. If the number of carbon atoms is 12 or greater, the water-repellency will tend to be even more easily improved when the water-repellent and oil-repellent composition containing the non-fluorine acrylic polymer has been adhered onto a fiber product. If the number of carbon atoms is 40 or less, then when the water-repellent and oil-repellent composition containing the non-fluorine acrylic polymer has been adhered onto a fiber product, the texture of the fiber product will tend to be further improved.

The number of carbon atoms of the hydrocarbon group is more preferably 12 to 24. If the number of carbon atoms is within this range, the water-repellency and texture will be particularly superior. Particularly preferred as hydrocarbon groups are straight-chain alkyl groups of 12 to 22 carbon atoms.

Examples for component (A) include stearyl (meth)acrylate, cetyl (meth)acrylate, lauryl (meth)acrylate, dodecyl (meth)acrylate, myristyl (meth)acrylate, pentadecyl (meth)acrylate, heptadecyl (meth)acrylate, nonadecyl (meth)acrylate, eicosyl (meth)acrylate, heneicosyl (meth)acrylate, behenyl (meth)acrylate, ceryl (meth)acrylate and melissyl (meth)acrylate.

Component (A) may have one or more functional groups selected from the group consisting of hydroxy groups, amino groups, carboxy groups, epoxy groups and isocyanate groups that are reactive with crosslinking agents. This can further improve the durable water-repellency of the obtained fiber product. An isocyanate group may also form a blocked isocyanate group protected with a blocking agent. If component (A) has an amino group, it will be possible to further improve the texture of the obtained fiber product.

Component (A) is preferably a monofunctional (meth)acrylic acid ester monomer having one polymerizable unsaturated group in the molecule.

Component (A) may be a single one used alone, or a combination of two or more.

Component (A) may also be used in combination with an acrylic acid ester monomer (a1) and a methacrylic acid ester monomer (a2), from the viewpoint of durable water-repellency of the obtained fiber product.

From the viewpoint of water-repellency and durable water-repellency of the obtained fiber product, the total constituent ratio of monomers of component (A) in the non-fluorine acrylic polymer is preferably 50 to 100 mass %, more preferably 55 to 100 mass % and even more preferably 60 to 100 mass %, with respect to the total amount of monomer components composing the non-fluorine-based polymer.

From the viewpoint of further improving the water-repellency of obtained fiber products and the emulsification stability of the non-fluorine acrylic polymer in the composition during emulsion polymerization or dispersion polymerization and after polymerization, the non-fluorine acrylic polymer preferably contains as a monomer component, in addition to component (A), at least one reactive emulsifier (B) (hereunder also referred to as “component (B)”), selected from among (B)) compounds represented by general formula (I-1) with an HLB of 7 to 18, (B2) compounds represented by general formula (II-1) with an HLB of 7 to 18, and (B3) compounds obtained by addition of an alkylene oxide of 2 to 4 carbon atoms to a fat or oil with a hydroxyl group and a polymerizable unsaturated group, and having an HLB of 7 to 18.

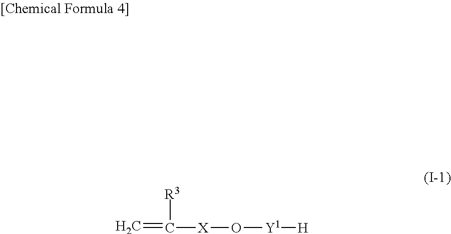

[In formula (I-1), R³ represents hydrogen or a methyl group, X represents a straight-chain or branched alkylene group having 1 to 6 carbon atoms, and Y¹ represents a divalent group containing an alkyleneoxy group having 2 to 4 carbon atoms.].

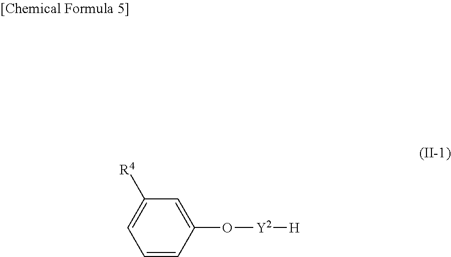

[In formula (II-1), R⁴ represents a monovalent unsaturated hydrocarbon group having 13 to 17 carbon atoms with a polymerizable unsaturated group, and Y² represents a divalent group containing an alkyleneoxy group having 2 to 4 carbon atoms.]

The term “reactive emulsifier” refers to an emulsifying dispersant having radical reactivity, i.e. a surfactant having one or more polymerizable unsaturated groups in the molecule, and it can be copolymerized with a monomer such as a (meth)acrylic acid ester.

The HLB of the compounds of (B1) to (B3) used for the embodiment is preferably 7 to 18, and it is preferably 9 to 15 from the viewpoint of emulsification stability in the composition, either during emulsion polymerization or dispersion polymerization or after polymerization of the non-fluorine acrylic polymer (hereunder referred to simply as “emulsification stability”). From the viewpoint of storage stability of the water-repellent and oil-repellent composition, it is more preferred to use a combination of two or more reactive emulsifiers (B) with different HLBs within this range.

In a reactive emulsifier (B1) represented by general formula (I-1) above to be used for this embodiment, R³ is hydrogen or a methyl group, and it is more preferably a methyl group from the viewpoint of copolymerizability with component (A). X is a straight-chain or branched alkylene group having 1 to 6 carbon atoms, and it is more preferably a straight-chain alkylene group having 2 to 3 carbon atoms from the viewpoint of the emulsification stability of the non-fluorine acrylic polymer of the embodiment. Y¹ is a divalent group containing an alkyleneoxy group having 2 to 4 carbon atoms. The type, combination and number of added alkyleneoxy groups for Y¹ may be appropriately selected so that the HLB is within the aforementioned range. When two or more alkyleneoxy groups are present, they may have a block addition structure or random addition structure.

Compounds represented by general formula (I-1) are preferably compounds represented by the following general formula (I-2)

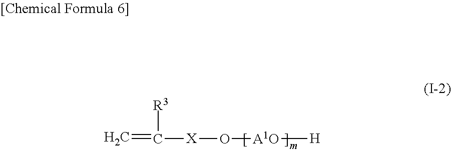

[In formula (I-2), R³ represents hydrogen or a methyl group, X represents a straight-chain or branched alkylene group having 1 to 6 carbon atoms, A¹O represents an alkyleneoxy group having 2 to 4 carbon atoms, in may be appropriately selected so that the HLB is within the range specified above, with an integer of 1 to 80 being preferred, and when m is 2 or greater the in A¹O groups may be the same or different.]

In the compound represented by general formula (I-2) above, R³ is hydrogen or a methyl group, and it is more preferably a methyl group from the viewpoint of copolymerizability with component (A). X is a straight-chain or branched alkylene group having 1 to 6 carbon atoms, and it is more preferably a straight-chain alkylene group having 2 to 3 carbon atoms from the viewpoint of the emulsification stability of the non-fluorine acrylic polymer. A¹O is an alkyleneoxy group having 2 to 4 carbon atoms. The type and combination of A¹O groups, and the number for m, may be appropriately selected so that the HLB is within the aforementioned range. From the viewpoint of the emulsification stability of the non-fluorine acrylic polymer, m is preferably an integer of 1 to 80 and more preferably an integer of 1 to 60. When m is 2 or greater, the m number of A¹O groups may be the same or different. When two or more A¹O groups are present, they may have a block addition structure or random addition structure.

The reactive emulsifier (B1) represented by general formula (I-2) may be obtained by a method known in the prior art, with no particular restrictions. It is also easily available from commercial products, examples of which include “LATEMUL PD-420”, “LATEMUL PD-430” and “LATEMUL PD-450” by Kao Corp.

In a reactive emulsifier (B2) represented by general formula (II-1) above to be used for the embodiment, R⁴ is a monovalent unsaturated hydrocarbon group having 13 to 17 carbon atoms with a polymerizable unsaturated group, examples of which include tridecenyl, tridecadienyl, tetradecenyl, tetradienyl, pentadecenyl, pentadecadienyl, pentadecatrienyl, heptadecenyl, heptadecadienyl and heptadecatrienyl groups. From the viewpoint of emulsification stability of the non-fluorine-based polymer, R⁴ is more preferably a monovalent unsaturated hydrocarbon group having 14 to 16 carbon atoms.

Y² is a divalent group containing an alkyleneoxy group having 2 to 4 carbon atoms. The type, combination and number of added alkyleneoxy groups for Y² may be appropriately selected so that the HLB is within the aforementioned range. When two or more alkyleneoxy groups are present, they may have a block addition structure or random addition structure. From the viewpoint of emulsification stability of the non-fluorine acrylic polymer, the alkyleneoxy group is more preferably an ethyleneoxy group.

A compound represented by general formula (II-1) is preferably a compound represented by the following general formula (II-2).

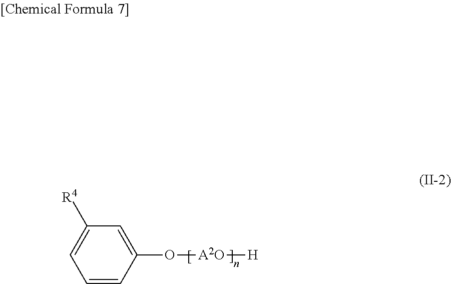

[In formula (II-2), R⁴ represents a monovalent unsaturated hydrocarbon group having 13 to 17 carbon atoms with a polymerizable unsaturated group, A²O represents an alkyleneoxy group having 2 to 4 carbon atoms, n may be appropriately selected so that the HLB is within the range specified above, with an integer of 1 to 50 being preferred, and when n is 2 or greater, the n A²O groups may be the same or different.]

R⁴ in the compound represented by general formula (II-2) may be the same as R⁴ in general formula (II-1).

A²O is an alkyleneoxy group having 2 to 4 carbon atoms. From the viewpoint of the emulsification stability of the non-fluorine acrylic polymer, the type and combination of A²O, and the number of n, may be appropriately selected so that the HLB is within the range specified above. From the viewpoint of emulsification stability of the non-fluorine acrylic polymer, A²O is more preferably an ethyleneoxy group, and n is preferably an integer of 1 to 50, more preferably an integer of 5 to 20 and even more preferably an integer of 8 to 14. When n is 2 or greater, the n number of A²O groups may be the same or different. When two or more A²O groups are present, they may have a block addition structure or random addition structure.

The reactive emulsifier (B2) represented by general formula (II-2) used for the embodiment can be synthesized by adding an alkylene oxide to a phenol having an unsaturated hydrocarbon group, according to a conventionally known method, with no particular restrictions. For example, it may be synthesized using an alkali catalyst such as caustic soda or caustic potassium, with addition of a predetermined amount of alkylene oxide at 120 to 170° C. under pressure.

Phenols with the corresponding unsaturated hydrocarbon group include industrially produced pure products or mixtures, as well as pure products or mixtures extracted and purified from plants. Examples include 3-[8(Z), 11(Z), 14-pentadecatrienyl]phenol, 3-[8(Z), 11(Z)-pentadecadienyl]phenol, 3-[8(Z)-pentadecenyl]phenol and 3-[11(Z)-pentadecenyl]phenol, which are extracted from cashew nut shells and are collectively known as cardanols.

The reactive emulsifier (B3) used for the embodiment is a compound with an HLB of 7 to 18, obtained by adding an alkylene oxide of 2 to 4 carbon atoms to an oil with a hydroxyl group and a polymerizable unsaturated group. Fats and oils with hydroxyl groups and polymerizable unsaturated groups include mono- or diglycerides of fatty acids optionally including unsaturated fatty acids (such as palmitoleic acid, oleic acid, linoleic acid, α-linolenic acid, arachidonic acid, eicosapentaenoic acid and docosapentaenoic acid), and triglycerides of fatty acids comprising at least one hydroxy unsaturated fatty acid (such as ricinolic acid, ricinoelaidic acid and 2-hydroxytetracosenoic acid). From the viewpoint of emulsification stability of the non-fluorine-based polymer, alkylene oxide addition products of triglycerides of fatty acids containing at least one hydroxy unsaturated fatty acid are preferred, alkylene oxide addition products (2 to 4 carbon atoms) of castor oil (a triglyceride of ricinolic acid-containing fatty acid) are more preferred, and ethylene oxide addition product of castor oil is even more preferred. The number of moles of alkylene oxide addition may be appropriately selected so that the FILL is within the range specified above, and from the viewpoint of emulsification stability of the non-fluorine acrylic polymer it is more preferably 20 to 50 mol and even more preferably 25 to 45 mol. When two or more alkylene oxides are present, they may have a block addition structure or random addition structure.

The reactive emulsifier (B3) used for the embodiment can be synthesized by adding an alkylene oxide to a fat or oil having a hydroxyl group and a polymerizable unsaturated group, according to a conventionally known method, with no particular restrictions. For example, it can be synthesized using an alkali catalyst such as caustic soda or caustic potassium, on a triglyceride of a fatty acid containing ricinolic acid, i.e. castor oil, and adding a predetermined amount of alkylene oxide at 120 to 170° C. under pressure.

From the viewpoint of further improving the water-repellency of obtained fiber products and the emulsification stability of the non-fluorine acrylic polymer, the constituent ratio of the monomer of component (B) in the non-fluorine acrylic polymer is preferably 0.5 to 20 mass %, more preferably 1 to 15 mass % and even more preferably 3 to 10 mass % with respect to the total amount of the monomer components composing the non-fluorine acrylic polymer.

From the viewpoint of further improving the durable water-repellency of the obtained fiber product, the non-fluorine acrylic polymer preferably contains, as a monomer component in addition to component (A), one or more second (meth)acrylic acid ester monomers (C) selected from the group consisting of the following (C1), (C2), (C3), (C4) and (C5) (hereunder also referred to as “component (C)”) as monomer components.

(C1) is a (meth)acrylic acid ester monomer represented by the following general formula (C-1), other than (C5).

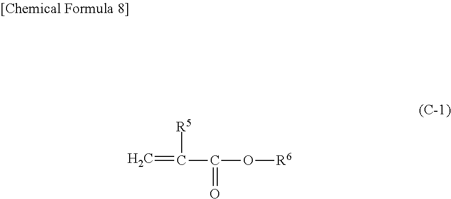

[In formula (C-1), R⁵ represents hydrogen or a methyl group, and R⁶ represents a monovalent straight-chain hydrocarbon group having 1 to 11 carbon atoms having at least one type of functional group selected from the group consisting of hydroxy, amino, carboxy, epoxy, isocyanate and (meth)acryloyl oxy groups. However, the number of (meth)acryloyloxy groups in the molecule is 2 or less.]

(C2) is a (meth)acrylic acid ester monomer represented by the following general formula (C-2).

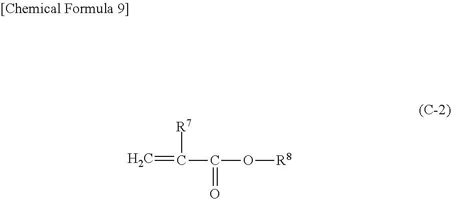

[In formula (C-2), R⁷ represents hydrogen or a methyl group, and R⁸ represents a monovalent cyclic hydrocarbon group having 1 to 11 carbon atoms, which is optionally substituted.]

(C3) is a methacrylic acid ester monomer represented by the following general formula (C-3).

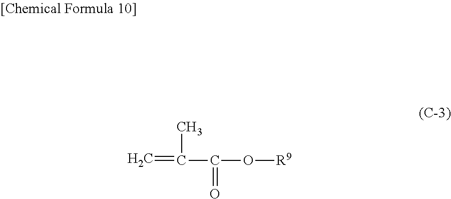

[In formula (C-3), R⁹ represents an unsubstituted monovalent straight-chain hydrocarbon group having 1 to 4 carbon atoms.]

(C4) is a (meth)acrylic acid ester monomer represented by the following general formula (C-4).

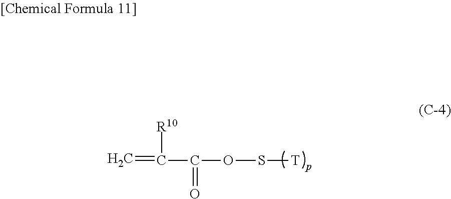

[In formula (C-4), R¹⁰ represents hydrogen or a methyl group, p represents an integer of 2 or greater, S represents a (p+1)-valent organic group, and T represents a monovalent organic group with a polymerizable unsaturated group.]

(C5) is a (meth)acrylic acid ester monomer represented by the following general formula (C-5).

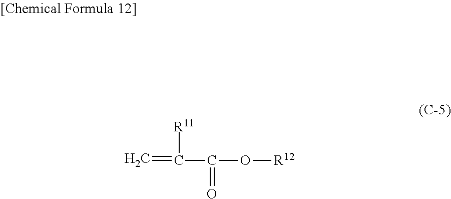

[In formula (C-5), R¹¹ represents hydrogen or a methyl group, and R¹² represents a monovalent linear saturated hydrocarbon group having 3 to 6 carbon atoms having a hydroxyl group and at least one functional group selected from the group consisting of chloro and bromo groups.]

The monomer of (C1) is a (meth)acrylic acid ester monomer with a monovalent straight-chain hydrocarbon group having 1 to 11 carbon atoms having at least one type of functional group selected from the group consisting of hydroxy, amino, carboxy, epoxy, isocyanate and (meth)acryloyloxy groups in the ester portion, and it is a (meth)acrylic acid ester monomer other than (C5). From the viewpoint of allowing reaction with the crosslinking agent, the monovalent straight-chain hydrocarbon group having 1 to 11 carbon atoms preferably has one or more functional groups selected from the group consisting of hydroxy, amino, carboxy, epoxy and isocyanate groups. When a non-fluorine acrylic polymer comprising a monomer of (C1) having a group that can react with such a crosslinking agent is treated with a fiber product together with the crosslinking agent, it is possible to further improve the durable water-repellency while maintaining the texture of the obtained fiber product. An isocyanate group may also form a blocked isocyanate group protected with a blocking agent.

The straight-chain hydrocarbon group may be straight-chain or branched, and may be a saturated hydrocarbon group or unsaturated hydrocarbon group. The straight-chain hydrocarbon group may also have another substituent in addition to the aforementioned functional groups.

Preferred among these are straight-chain and/or saturated hydrocarbon groups, from the viewpoint of further improving the durable water-repellency of the obtained fiber product.

Specific (C1) monomers include 2-hydroxyethyl (meth)acrylate, dimethylaminoethyl (meth)acrylate, glycidyl (meth)acrylate and 1,1-bis(acryloyloxymethyl)ethyl isocyanate. These monomers may be used alone or in combinations of two or more. Preferred among these are 2-hydroxyethyl (meth)acrylate, glycidyl (meth)acrylate and 1,1-bis(acryloyloxymethyl)ethyl isocyanate, from the viewpoint of further improving the durable water-repellency of the obtained fiber product. Dimethylaminoethyl (meth)acrylate is preferred from the viewpoint of further improving the texture of the obtained fiber product.

From the viewpoint of the water-repellency and texture of the obtained fiber product, the constituent ratio of the monomer (C1) in the non-fluorine acrylic polymer is preferably 1 to 30 mass %, more preferably 3 to 25 mass % and even more preferably 5 to 20 mass % with respect to the total amount of monomer components composing the non-fluorine acrylic polymer.

The monomer of (C2) is a (meth)acrylic acid ester monomer having a monovalent cyclic hydrocarbon group having 1 to 11 carbon atoms in the ester portion, with cyclic hydrocarbon groups including isobornyl, cyclohexyl and dicyclopentanyl. These cyclic hydrocarbon groups may also have substituents such as alkyl groups. When the substituents are hydrocarbon groups, however, the hydrocarbon groups are selected so that the total number of carbon atoms of the substituents and cyclic hydrocarbon groups is 11 or less. These cyclic hydrocarbon groups are preferably directly bonded to ester bonds from the viewpoint of further improving the durable water-repellency. The cyclic hydrocarbon group may be an alicyclic or aromatic group, and in the case of an alicyclic group, it may be a saturated hydrocarbon group or an unsaturated hydrocarbon group. Specific monomers include isobornyl (meth)acrylate, cyclohexyl (meth)acrylate and dicyclopentanyl (meth)acrylate. These monomers may be used alone or in combinations of two or more. Isobornyl (meth)acrylate and cyclohexyl methacrylate are preferred and isobornyl methacrylate is more preferred, from the viewpoint of further improving the durable water-repellency of the obtained fiber product.

From the viewpoint of the water-repellency and texture of the obtained fiber product, the constituent ratio of the monomer (C2) in the non-fluorine acrylic polymer is preferably 1 to 30 mass %, more preferably 3 to 25 mass % and even more preferably 5 to 20 mass % with respect to the total amount of monomer components composing the non-fluorine acrylic polymer.

The (C3) monomer is a methacrylic acid ester monomer having an unsubstituted monovalent straight-chain hydrocarbon group having 1 to 4 carbon atoms directly bonded to the ester bond of the ester portion. Preferred straight-chain hydrocarbon groups of 1 to 4 carbon atoms are straight-chain hydrocarbon groups of 1 to 2 carbon atoms and branched hydrocarbon groups of 3 to 4 carbon atoms. Examples of straight-chain hydrocarbon groups of 1 to 4 carbon atoms include methyl, ethyl, n-propyl, isopropyl, n-butyl and t-butyl. Specific compounds include methyl methacrylate, ethyl methacrylate, n-propyl methacrylate, isopropyl methacrylate, n-butyl methacrylate, isobutyl methacrylate and t-butyl methacrylate. These monomers may be used alone or in combinations of two or more. Methyl methacrylate, isopropyl methacrylate and t-butyl methacrylate are preferred and methyl methacrylate is more preferred from the viewpoint of further improving the durable water-repellency of the obtained fiber product.

From the viewpoint of water-repellency and texture of the obtained fiber product, the constituent ratio of monomers of (C3) in the non-fluorine acrylic polymer is preferably 1 to 30 mass %, more preferably 3 to 25 mass % and even more preferably 5 to 20 mass %, with respect to the total amount of monomer components composing the non-fluorine-based polymer.

The (C4) monomer is a (meth)acrylic acid ester monomer having 3 or more polymerizable unsaturated groups in the molecule. For this embodiment, a polyfunctional (meth)acrylic acid ester monomer with 3 or more (meth)acryloyloxy groups in the molecule, wherein T in general formula (C-4) is a (meth)acryloyloxy group, is preferred. In formula (C-4), the p number of T groups may be the same or different. Specific examples of such compounds include ethoxylated isocyanuric acid triacrylate, tetramethylolmethane tetraacrylate, tetramethylolmethane tetramethacrylate, trimethylolpropane triacrylate, trimethylolpropane trimethacrylate, pentaerythritol triacrylate, pentaerythritol trimethacrylate, dipentaerythritol hexaacrylate and dipentaerythritol hexamethacrylate. These monomers may be used alone or in combinations of two or more. Tetramethylolmethane tetraacrylate and ethoxylated isocyanuric acid triacrylate are more preferred from the viewpoint of further improving the durable water-repellency of the obtained fiber product.

From the viewpoint of water-repellency and texture of the obtained fiber product, the constituent ratio of the monomer (C4) in the non-fluorine acrylic polymer is preferably 1 to 30 mass/%, more preferably 3 to 25 mass % and even more preferably 5 to 20 mass % with respect to the total amount of monomer components composing the non-fluorine acrylic polymer.

The monomer of (C5) has a monovalent linear saturated hydrocarbon group having 3 to 6 carbon atoms having a hydroxyl group and at least one type of functional group selected from the group consisting of chloro groups and bromo groups. In the monomer of (C5) above, R¹¹ is hydrogen or a methyl group. From the viewpoint of durable water-repellency of the obtained fiber product, R¹¹ is preferably a methyl group.

R¹² is a monovalent linear saturated hydrocarbon group having 3 to 6 carbon atoms having a hydroxyl group and at least one type of functional group selected from the group consisting of chloro groups and bromo groups. The linear saturated hydrocarbon group may be straight-chain or branched. If the linear saturated hydrocarbon group is straight-chain, then the durable water-repellency of the obtained fiber product will be even more excellent. The number of carbon atoms of the linear saturated hydrocarbon group is preferably 3 to 4 and more preferably 3, from the viewpoint of durable water-repellency of the obtained fiber product.

From the viewpoint of durable water-repellency of the obtained fiber product, the linear saturated hydrocarbon group preferably has one or two chloro groups and one hydroxyl group, and more preferably it has one chloro group and one hydroxyl group. From the viewpoint of durable water-repellency of the obtained fiber product, the linear saturated hydrocarbon group more preferably has a hydroxyl group at the β-position (the carbon atom adjacent to the carbon atom bonded to CH₂=CR¹¹(CO)O—). Specific examples of such linear saturated hydrocarbon groups include 3-chloro-2-hydroxylpropyl, 3-chloro-2-hydroxybutyl, 5-chloro-2-hydroxypentyl, 3-chloro-2-hydroxy-2-methylpropyl and 3-bromo-2-hydroxypropyl groups.

Examples of specific (C5) monomers include 3-chloro-2-hydroxypropyl (meth)acrylate, 3-chloro-2-hydroxybutyl (meth)acrylate, 5-chloro-2-hydroxypentyl (meth)acrylate and 3-bromo-2-hydroxypropyl (meth)acrylate. From the viewpoint of further improving the durable water-repellency of the obtained fiber product, 3-chloro-2-hydroxypropyl (meth)acrylate is preferred and 3-chloro-2-hydroxypropyl methacrylate is more preferred.

From the viewpoint of the durable water-repellency of the obtained fiber product, the constituent ratio of the (C5) monomer in the non-fluorine acrylic polymer is preferably 1 to 30 mass %, more preferably 3 to 25 mass % and even more preferably 5 to 20 mass % with respect to the total amount of monomer components composing the non-fluorine acrylic polymer.

From the viewpoint of water-repellency and texture of the obtained fiber product, the total constituent ratio of the monomer of component (C) in the non-fluorine acrylic polymer is preferably 1 to 30 mass %, more preferably 3 to 25 mass % and even more preferably 5 to 20 mass % with respect to the total amount of monomer components composing the non-fluorine acrylic polymer.

The non-fluorine acrylic polymer may also contain, in addition to component (A), component (B) and component (C), a monofunctional monomer (D) that is copolymerizable with them (hereunder also referred to as “component (D)”), in a range that does not interfere with the effect of the invention.

Examples for the monomer of (D) include fluorine-free vinyl-based monomers other than component (E) mentioned below, such as (meth)acryloylmorpholine, (meth)acrylic acid esters having hydrocarbon groups other than component (A) and component (C), (meth)acrylic acid, fumaric acid esters, maleic acid esters, fumaric acid, maleic acid, (meth)acrylamide, N-methylolacrylamide, vinyl ethers, vinyl esters, ethylene and styrene. A (meth)acrylic acid ester having a hydrocarbon group other than component (A) and component (C) may have a substituent such as a vinyl, hydroxy, amino, epoxy, isocyanate or blocked isocyanate group on the hydrocarbon group, or it may have a substituent other than a group that can react with a crosslinking agent, such as a quaternary ammonium group, or it may have an ether bond, ester bond, amide bond or urethane bond Examples of (meth)acrylic acid esters other than component (A) and component (C) include methyl acrylate, 2-ethylhexyl (meth)acrylate, benzyl (meth)acrylate and ethylene glycol di(meth)acrylate.

From the viewpoint of the water-repellency and texture of the obtained fiber product, the constituent ratio of the monomer of component (D) in the non-fluorine acrylic polymer is preferably 10 mass % or lower with respect to the total amount of monomer components composing the non-fluorine acrylic polymer.

The non-fluorine acrylic polymer preferably has at least one type of functional group selected from the group consisting of hydroxyl, amino, carboxy, epoxy and isocyanate groups that are reactive with the crosslinking agent, in order to further improve the durable water-repellency of the obtained fiber product. An isocyanate group may also form a blocked isocyanate group protected with a blocking agent. A non-fluorine acrylic polymer preferably has an amino group, in order to further improve the texture of the obtained fiber product.

From the viewpoint of further improving the water-repellency of the obtained fiber product and the coating peel strength, the non-fluorine acrylic polymer preferably comprises, as a monomer component in addition to component (A), at least one type of monomer (E) from among vinyl chloride and vinylidene chloride (hereunder also referred to as “component (E)”).

The monomer (E) of one or more types from among vinyl chloride and vinylidene chloride used for the embodiment is preferably vinyl chloride, from the viewpoint of water-repellency of the obtained fiber product and coating peel strength.

From the viewpoint of further improving the peel strength for coating of the obtained fiber product, the constituent ratio of the monomer of component (E) in the non-fluorine acrylic polymer is preferably 1 to 45 mass %, more preferably 3 to 40 mass % and even more preferably 5 to 35 mass % with respect to the total amount of monomer components composing the non-fluorine acrylic polymer.

A method for producing the aforementioned non-fluorine acrylic polymer will now be described.

A non-fluorine acrylic polymer can be produced by a radical polymerization method. Among radical polymerization methods, the polymerization is preferably carried out by emulsion polymerization or dispersion polymerization in terms of performance of the obtained water-repellent and oil-repellent agent, and from environmental considerations.

The (meth)acrylic acid ester monomer (A) represented by general formula (A-1) may be subjected to, for example, emulsion polymerization or dispersion polymerization in a medium, to obtain a non-fluorine acrylic polymer. More specifically, component (A) and if necessary component (B), component (C), component (D) and component (E), as well as an emulsification aid or dispersion aid, may be added to the medium and the mixture may be emulsified or dispersed to obtain an emulsion or dispersion. By adding a polymerization initiator to the obtained emulsion or dispersion, polymerization reaction is initiated, allowing the monomer and reactive emulsifier to be polymerized. The means for emulsifying or dispersing the liquid mixture may be a homomixer, high-pressure emulsifier or ultrasonic waves.

The emulsification aid or dispersion aid used (hereunder also referred to collectively as “emulsification aid or the like”) may be one or more selected from among nonionic surfactants, cationic surfactants, anionic surfactants and amphoteric surfactants, other than the reactive emulsifier (B). The content of an emulsification aid or the like is preferably 0.5 to 30 parts by mass, more preferably 1 to 20 parts by mass and even more preferably 1 to 10 parts by mass, with respect to 100 parts by mass of the total monomers. If the content of the emulsification aid or the like is 0.5 parts by mass or greater the dispersion stability of the liquid mixture will tend to be further improved, and if the content of the emulsification aid or the like is 30 parts by mass or lower the water-repellency of the obtained water-repellent and oil-repellent composition will tend to be further improved.

The emulsion polymerization or dispersion polymerization medium is preferably water, and if necessary the water may be mixed with an organic solvent. Examples of organic solvents include alcohols such as methanol and ethanol, esters such as ethyl acetate, ketones such as acetone and methyl ethyl ketone, ethers such as diethyl ether, and glycols such as propylene glycol, dipropylene glycol and tripropylene glycol. The ratio of water and organic solvent is not particularly restricted.

The polymerization initiator used may be a known azo-based, peroxide-based or redox-based polymerization initiator. The polymerization initiator content is preferably 0.01 to 2 parts by mass of the polymerization initiator with respect to 100 parts by mass of the total monomers. If the polymerization initiator content is within this range it will be possible to efficiently produce a non-fluorine acrylic polymer with a weight-average molecular weight of 100,000 or greater.

A chain transfer agent such as dodecylmercaptane or t-butyl alcohol may also be used in the polymerization reaction in order to modify the molecular weight.

A polymerization inhibitor may also be used for modification of the molecular weight. Addition of a polymerization inhibitor can easily yield a non-fluorine acrylic polymer having the desired weight-average molecular weight.

The temperature for the polymerization reaction is preferably 20° C. to 150° C. A temperature of 20° C. or higher will tend to result in adequate polymerization, while a temperature of 150° C. or lower will tend to help control the heat of reaction.

For the polymerization reaction, the weight-average molecular weight of the obtained non-fluorine acrylic polymer can be adjusted by increasing or decreasing the contents of the polymerization initiator, chain transfer agent and polymerization inhibitor, and the melt viscosity at 105° C. can be adjusted by increasing or decreasing the polyfunctional monomer content and polymerization initiator content. When it is desired to lower the melt viscosity at 105° C., the content of the monomer with two or more polymerizable functional groups may be reduced or the polymerization initiator content may be increased.

From the viewpoint of storage stability and handleability of the composition, the content of the non-fluorine acrylic polymer in the polymer emulsion liquid or dispersion liquid obtained by emulsion polymerization or dispersion polymerization is preferably 10 to 50 mass % and more preferably 20 to 40 mass % with respect to the total amount of the emulsion liquid or dispersion liquid.

Examples of hydrocarbon group-containing compounds include NEOSEED NR-90 (product of Nicca Chemical Co., Ltd.), NR-158 (product of Nicca Chemical Co., Ltd.), TH-44 (product of Nicca Chemical Co., Ltd.), PW-182 (product of Daiwa Chemical Industries Co., Ltd.), PHOBOL RSH (product of Huntsman, Japan), PARAGIUM ECO-500 (product of Ohara Paragium Chemical Co. Ltd.) and NX018 (product of Nanotex Corp.).

### <Other Components>

The water-repellent and oil-repellent composition of the embodiment may further comprise, in addition to the components mentioned above, a surfactant, antifoaming agent, organic acid, inorganic acid, alcohol, antimicrobial agent, mildewproofing agent, pH adjustor, coloring agent, silica, antioxidant, deodorant, catalyst, emulsion stabilizer, organic solvent, chelating agent or antistatic agent, an organo-modified silicone other than an amino-modified silicone, or a crosslinking agent other than polyfunctional isocyanate.

The surfactant requires a polyalkylene oxide adduct, but it may further include another surfactant. The other surfactant used may be one that provides a function of widening the temperature range in which a stable emulsion state is maintained, and of adjusting the volume of foam generated when the mixture is added to water to prepare a diluted solution. The other surfactant may be one composed of a nonionic surfactant, an anionic surfactant, a cationic surfactant or an amphoteric surfactant. The other surfactant may be used alone as a single type, or two or more may be used in combination.

Examples of antifoaming agents include, but are not particularly limited to, fat- and oil-based antifoaming agents such as castor oil, sesame oil, linseed oil and animal or vegetable oils; fatty acid-based antifoaming agents such as stearic acid, oleic acid and palmitic acid; fatty acid ester-based antifoaming agents such as isoamyl stearate, distearyl succinate, ethylene glycol distearate and butyl stearate; alcohol-based antifoaming agents such as polyoxyalkylene monohydric alcohols, di-t-amylphenoxyethanol, 3-heptanol and 2-ethylhexanol; ether-based antifoaming agents such as di-t-amylphenoxyethanol and 3-heptylcellosolve nonylcellosolve 3-heptylcarbitol; phosphoric acid ester-based antifoaming agents such as tributyl phosphate and tris(butoxyethyl) phosphate, amine-based antifoaming agents such as diamylamine; amide-based antifoaming agents such as polyalkyleneamides and acylatepolyamine; sulfuric acid ester-based antifoaming agents such as sodium lauryl sulfate ester; and mineral oils. Any of these antifoaming agents may be used alone or in combinations of two or more.

There are no particular restrictions on organic acids, and examples include lactic acid, acetic acid, propionic acid, maleic acid, oxalic acid, formic acid, methanesulfonic acid and toluenesulfonic acid. Any of these organic acids may be used alone or in combinations of two or more.

There are no particular restrictions on inorganic acids, and examples include hydrochloric acid, sulfuric acid and nitric acid. Any of these inorganic acids may be used alone or in combinations of two or more.

There are no particular restrictions on alcohols, and examples include ethanol, isopropanol, glycerin, trimethylolpropane, diethylene glycol, triethylene glycol, dipropylene glycol and propylene glycol. Any of these alcohols may be used alone or in combinations of two or more.

An antistatic agent used may be one that is unlikely to inhibit the water-repellent performance. Examples of antistatic agents include cationic surfactants such as higher alcohol sulfuric acid ester salts, sulfated oils, sulfonic acid salts, quaternary ammonium salts and imidazoline-type quaternary salts, nonionic surfactants such as polyethylene glycol-type and polyhydric alcohol ester-types, amphoteric surfactants such as imidazoline-type quaternary salts, alanine-type and betaine-type types, and antistatic polymers and polyalkylamines as polymer compound types. Any of these antistatic agents may be used alone or in combinations of two or more.

Examples of crosslinking agents other than the aforementioned polyfunctional isocyanates include melamine resins and glyoxal resins. A melamine resin used may be a compound with a melamine backbone, examples of which include polymethylolmelamines such as trimethylolmelamine and hexamethylolmelamine; alkoxymethylmelamines wherein all or a portion of the methylol groups of the polymethylolmelamine are alkoxymmethyl groups each with an alkyl group having 1 to 6 carbon atoms; and acyloxymethylmelamines wherein all or a portion of the methylol groups of the polymethylolmelamine are acyloxymethyl groups each with an acyl group having 2 to 6 carbon atoms. These melamine resins may be monomers or multimers that are dimers or greater, or mixtures thereof may be used. There may also be used compounds obtained by co-condensation of urea on some of the melamines. Examples of such melamine resins include BECKAMINE APM, BECKAMINE M-3, BECKAMINE M-3(60), BECKAMINE MA-S, BECKAMINE J-101 and BECKAMINE J-101LF, by DIC Corp, UNIKA RESIN 380K by Union Chemical Co., and the RIKEN RESIN MM Series by Mikiriken Industrial Co., Ltd.

A glyoxal resin that is used may be a conventionally known one. Examples of glyoxal resins include 1,3-dimethylglyoxalurea-based resins, dimethylol dihydroxyethylene urea-based resins and dimethylol dihydroxypropylene urea-based resins. The functional groups of such resins may also be substituted with other functional groups. Examples of such glyoxal resins include BECKAMINE N-80, BECKAMINE NS-11, BECKAMINE LF-K, BECKAMINE NS-19, BECKAMINE LF-55P CONCH, BECKAMINE NS-210L, BECKAMINE NS-200 and BECKAMINE NF-3, by DIC Corp., UNIRESIN GS-20E by Union Chemical Co., and the RIKEN RESIN RG Series and RIKEN RESIN MS Series by Mikiriken Industrial Co., Ltd.

A catalyst is preferably used for melamine resins and glyoxal resins from the viewpoint of promoting the reaction. Such catalysts are not particularly restricted so long as they are commonly used catalysts, and examples include borofluoride compounds such as ammonium borofluoride and zinc borofluoride; neutral metal salt catalysts such as magnesium chloride and magnesium sulfate; and inorganic acids such as phosphoric acid, hydrochloric acid and boric acid. If necessary, these catalysts may be combined with organic acids such as citric acid, tartaric acid, malic acid, maleic acid and lactic acid as co-catalysts. Examples of such catalysts include CATALYST ACX, CATALYST 376, CATALYST 0, CATALYST M, CATALYST G (GT), CATALYST X-110, CATALYST GT-3 and CATALYST NFC-1 by DIC Corp., UNIKA CATALYST 3-P and UNIKA CATALYST MC-109 by Union Chemical Co., and the RIKEN FIXER RC Series, the RIKEN FIXER MX Series and RIKEN FIXER RZ-5 by Mikiriken Industrial Co., Ltd.

The water-repellent and oil-repellent composition of the embodiment can be suitably used for purposes such as fiber product finishing agents, paper product finishing agents and leather product finishing agents.

### <Method for Producing Water-Repellent and Oil-Repellent Composition>

The embodiment also provides a method for producing a water-repellent and oil-repellent composition of the embodiment. The water-repellent and oil-repellent composition of the embodiment can be produced by emulsifying and dispersing the constituent components mentioned above for the composition. For example, it can be obtained by dissolving a silicone resin in an organic solvent and carrying out emulsifying dispersion using an emulsifier and an aqueous medium (silicone resin emulsified dispersion).

When the water-repellent and oil-repellent composition includes at least one compound selected from the group consisting of amino-modified silicones, alkylpolysiloxanes and polyfunctional isocyanates, it can be obtained by dissolving a silicone resin and at least one compound selected from the group consisting of amino-modified silicones, alkylpolysiloxanes and polyfunctional isocyanates in an organic solvent, and carrying out emulsifying dispersion using an emulsifier and an aqueous medium.

When the water-repellent and oil-repellent composition includes at least one compound selected from the group consisting of amino-modified silicones, alkylpolysiloxanes and polyfunctional isocyanates, it may be a single-dosage form pre-mixed with a silicone resin and at least one compound selected from the group consisting of amino-modified silicones, alkylpolysiloxanes and polyfunctional isocyanates, and for example, it may be a two-dosage form obtained by dissolving an emulsified dispersion of a silicone resin and at least one compound selected from the group consisting of amino-modified silicones, alkylpolysiloxanes and polyfunctional isocyanates in an organic solvent, and using an emulsifier and an aqueous medium to form an emulsified dispersion, or even a three-dosage from or four-dosage form. These may also be mixed to obtain a water-repellent and oil-repellent composition, or they may be subjected to high-pressure homogenizer treatment to obtain a water-repellent and oil-repellent composition.

From the viewpoint of handling convenience, the water-repellent and oil-repellent composition of the embodiment is preferably a single-dosage form or a two-dosage form.

The method of dispersing each of the components in an aqueous medium may be, for example, mixing and stirring the components, the organic solvent of the embodiment, the aqueous medium of the embodiment and the emulsifier of the embodiment. For mixing and stirring, a conventionally known emulsification disperser such as a Milder, high-speed stirrer, homogenizer, ultrasonic homogenizer, homomixer, bead mill, pearl mill, Dyno-Mill, Aspek mill, basket mill, ball mill, Nanomizer, Ultimizer or Starburst may be used. Any of these emulsification dispersers may be used alone or in combinations of two or more.

The aqueous medium used may be any of the organic solvents mentioned above under <Aqueous medium>. These aqueous media can be used as a mixed solvent with water to be included in the water-repellent and oil-repellent composition.

The dispersion may further include a surfactant from the viewpoint of dispersion stability. Such surfactants are not particularly restricted so long as they can improve the emulsified dispersion stability, and examples include publicly known nonionic surfactants, anionic surfactants, cationic surfactants and amphoteric surfactants. Any of these may be used alone or in combinations of two or more.

The water-repellent and oil-repellent composition used as a dispersion may be used directly as a treatment solution, or it may be diluted with an aqueous medium or a hydrophobic organic solvent to form a treatment solution, According to one aspect, the water-repellent and oil-repellent composition or treatment solution may include silicone resins, amino-modified silicones and alkylpolysiloxanes at a total of 0.5 to 70 mass %, 1 to 50 mass % or 1.5 to 45 mass %, for example. The treatment solution may contain a polyfunctional isocyanate and another crosslinking agent in a total amount of 0.1 to 5.0 mass %, 0.2 to 3.0 mass % or 0.3 to 2.0 mass %, for example.

### <Water-Repellent and Oil-Repellent Fiber Product and Method for Producing It>

This embodiment further provides a water-repellent and oil-repellent fiber product and a process for its production. According to one aspect, the water-repellent and oil-repellent fiber product of the embodiment can be produced by a method comprising a step of treating the fibers with a treatment solution containing the water-repellent and oil-repellent composition of the embodiment described above. According to one aspect, the water-repellent and oil-repellent fiber product is obtained by treatment of the fiber product by the water-repellent and oil-repellent composition of the embodiment (that is, by water and oil repellency treatment). According to one aspect, the water-repellent and oil-repellent fiber product includes a silicone resin and an emulsifier among the aforementioned components of the water-repellent and oil-repellent composition (a silicone resin, an organic solvent such that the amount of water necessary to dissolve 1 g of organic solvent at 20° C. is greater than 10 mL, an emulsifier, and an aqueous medium), and optionally further includes the organic solvent and/or aqueous medium.

The material of the fibers is not particularly restricted and may be natural fibers such as cotton, hemp, silk or wool, semisynthetic fibers such as rayon or acetate, synthetic fibers such as nylon, polyester, polyurethane or polypropylene, or composite fibers of the foregoing, or mixed spun fibers of the foregoing. The fibers may be in any form such as a yarn, fabric, nonwoven fabric or paper. The fibers may also be a fiber product.

When the water-repellent and oil-repellent composition includes a silicone resin and at least one compound selected from the group consisting of amino-modified silicones, alkylpolysiloxanes and polyfunctional isocyanates, for example, the method of treating the fibers with a treatment solution containing the water-repellent and oil-repellent composition of the embodiment may be a treatment method in which the treatment is carried out in one step using a treatment solution comprising a silicone resin and at least one component selected from the group consisting of amino-modified silicones, alkylpolysiloxanes and polyfunctional isocyanates, or a treatment method in which the treatment is carried out in 2, 3 or 4 steps using a treatment solution containing at least one of the four components and a treatment solution containing at least one other component. When treatment is carried out in 2 to 4 steps, the order of treatment of each of the components may be any order.

The method of treating the fibers with the treatment solution may be, for example, a processing method such as dipping, spraying or coating. When the water-repellent and oil-repellent composition contains water, it is preferably dried to remove the water after it adheres to the fibers.

The amount of adhesion of the water-repellent and oil-repellent composition of the embodiment onto the fibers may be appropriately adjusted depending on the degree of water-repellency required, but it is preferably adjusted so that the amount of adhesion of the water-repellent and oil-repellent composition (the total amount of adhesion of the silicone resin, amino-modified silicone and alkylpolysiloxane, according to one aspect) is 0.1 to 5 g, and more preferably 0.1 to 3 g, with respect to 100 g of the fibers. If the amount of adhesion of the water-repellent and oil-repellent composition is less than 0.1 g the fibers may not be able to exhibit sufficient water-repellency, and if it is greater than 5 g there may be economical disadvantages. The amount of adhesion is confirmed by a method using solvent extraction from a water-repellent fiber product, for example.

Heat treatment is also preferably carried out as appropriate after the water-repellent and oil-repellent composition of the embodiment has been adhered onto the fibers. There are no particular restrictions on the temperature conditions, but from the viewpoint of water-repellency, durable water-repellency and texture, it is preferably carried out at 110 to 180° C. for 1 to 5 minutes.

Since the water-repellent and oil-repellent fiber product of the embodiment exhibits excellent water-repellency and a soft hand quality, it can be suitably used for fibers in clothing articles and non-clothing articles, including down side fabrics, coats, blousons, windbreakers, blouses, dress shirts, skirts, slacks, gloves, caps, bedding side fabrics, bedding drying covers, curtains and tents.

### EXAMPLES

The present invention will now be further explained by Examples, with the understanding that the invention is in no way restricted by the Examples.

### <Production of Silicone Dispersion>

### [Materials]

### (Silicone Resin)

MQ-1600: Dow chemical

### (Organic Solvent)

Isoparaffin: Isoparaffin having 10 to 16 carbon atoms, IP-2028 by Idemitsu Kosan Co., Ltd., amount of water necessary for dissolution of 1 g of organic solvent: >1000 mL.
Mineral oil: D-40 by Idemitsu Kosan Co., Ltd., 30° C. kinematic viscosity: 20 mm²/s, amount of water necessary to dissolve 1 g of organic solvent: >1000 mL
Mineral spirits: product of Toyo Sekiyu Kagaku Co., Boiling point: 180 to 200° C., amount of water necessary to dissolve 1 g of organic solvent: >1000 mL

### (Aqueous Medium)

Isopropanol: product of Sankyo Chemical Co., Ltd., amount of water necessary to dissolve 1 g of organic solvent by Sankyo Chemical Co., Ltd.: ≤1 ml
Tripropylene glycol: product of Adeka Corp., amount of water necessary to dissolve 1 g of organic solvent: 1 mL

### (Alkylpolysiloxane)

Dimethylsilicone 1: DOWSIL SH 200 C Fluid 5 cSt (DowToray), viscosity measured according to JS K 2283:2000 (Ubbelohde viscometer) (25° C.): 5 eps
Dimethylsilicone 2: DOWSIL™ SH 200 Fluid 100 cSt (DowToray), viscosity measured according to JIS K2283:2000 (Ubbelohde viscometer) (25° C.): 100 cps
Dimethylsilicone 3: DOWSIL™ SH 200 Fluid 100 cSt (DowToray), viscosity measured according to JIS K2283:2000 (Ubbelohde viscometer) (25° C.): 1,000 cps
Dimethylsilicone 4: DOWSIL™ SH 200 Fluid 100 cSt (DowToray), viscosity measured according to JIS K2283:2000 (Ubbelohde viscometer) (25° C.): 10,000 eps

### (Amino-Modified Silicone)

Double-terminated monoamine: BY16-853U (DOW Toray), functional group equivalents: 460
Side chain diamine 1: KF-8005 (product of Shin-Etsu Chemical Co., Ltd.), functional group equivalents: 11,000
Side chain diamine 2: SF-8417 (product of DowToray), functional group equivalents: 1,800
Side chain diamine 3: KF-393 (product of Shin-Etsu Chemical Co., Ltd.), functional group equivalents: 350
Side chain monoamine: KF-864: (product of Shin-Etsu Chemical Co., Ltd.), functional group equivalents: 3,800

### (Emulsifier: Nonionic Surfactant)

Polyoxyethylene (7 mol) isodecyl ether: Synthetic product obtained by adding ethylene oxide (7 mol) to isodecyl alcohol (1 mol) by a common method, HLB 13.2
Polyoxyethylene (9 mol) isodecyl ether: Synthetic product obtained by adding ethylene oxide (9 mol) to isodecyl alcohol (1 mol) by a common method, HLB: 14.3

### (Emulsifier: Cationic Surfactant)

Lipocard T-28: Stearyltrimethylammonium chloride by Lion Corp.

### Production Example 1

After adding 200 g of isoparaffin and 250 g of MQ-1600 (as silicone resin) to a flask, the mixture was dissolved while heating at 80° C. To this there were added 25 g of polyoxyethylene (7 mol) isodecyl ether (as a nonionic surfactant), 5.0 g of Lipocard T-28 (as a cationic surfactant) and purified water, and the mixture was treated with a high-pressure homogenizer (Model 15 MR-8TBA by APV GAULIN Inc.) at 300 bar to obtain a dispersion containing 25 mass % of silicone resin as a water-repellent and oil-repellent component.

### Production Example 2 to 19

The same procedure was carried out as in Production Example 1, except for using the contents as shown in Table 1, to obtain dispersions each containing a total of 25 mass % of a silicone resin, amino-modified silicone and alkylpolysiloxane as water-repellent and oil-repellent components.

### <Production of Crosslinking Component Dispersion>

### [Crosslinking Component Dispersion 1]

### (Dimethylpyrazole (DMP) Blocked Hexamethylene Diisocyanate (HDI) Biuret)

To a reactor there were added 1 mol of DURANATE 24A-100 (hexamethylene diisocyanate biuret type, NCO functional groups: 3, 100 mass % content, trade name of Asahi Kasei Chemicals Corp.) and methylisobutyl ketone, and the mixture was heated to 60 to 70° C. Next, 3 mol of 3,5-dimethylpyrazole was slowly charged in and reaction was conducted at 60 to 70° C. until the isocyanate content reached zero as confirmed by an infrared spectrophotometer, to obtain a colorless transparent, viscous liquid composition containing 98.7 mass % of a dimethylpyrazole-blocked polyisocyanate compound.

After mixing 180 parts by mass of the obtained composition, 140 parts by mass of butyldiglycol as an organic solvent and 20 parts by mass of a 30 mol ethylene oxide addition product of tristyrenated phenol as a nonionic surfactant, the mixture was homogenized. After gradually loading water while stirring, homogenizer treatment was carried out at 30 MPa to obtain crosslinking component dispersion 1 containing 40 mass % of a dimethylpyrazole-blocked hexamethylene diisocyanate biuret.

### [Crosslinking Component Dispersion 2]

In a reactor equipped with a stirrer, thermometer, cooler and nitrogen gas inlet tube there were mixed 150 g of Vestanat 1890/100 (isophorone diisocyanate (IPDI) trimer, product of Evonik, NCO group content: 17.3%, NV: 100%) (NCO equivalents: 0.62 mol), and 150 g of diethyleneglycol ethyl methyl ether solvent (hereunder also abbreviated as MEDG) at room temperature (25° C.), as well as 59.6 g (0.62 mol) of dimethylpyrazole (hereunder abbreviated as DMP, product of Tokyo Chemical Industry Co., Ltd.) as a blocking agent, being added several times and preventing the temperature of the reaction mixture from rising above 50° C., after which the mixture was stirred for 1 hour. The Fourier transform infrared (FT-IR) spectrum was then measured, and the NCO group-derived peak (near 2260 cm⁻¹) disappeared, thus confirming blocking. Next, 21 g of NOIGEN XL-40 (HLB 10.5, product of Dai-ichi Kogyo Seiyaku Co., Ltd.) was added and the components were mixed while adding a small amount of purified water, to obtain crosslinking component dispersion 2 containing 20 mass % of the IPDI trimer/DMP blocked compound.

### [Crosslinking Component Dispersion 3]

(TDI⋅TMP⋅MEKO: Dispersion of methyl ethyl ketoxime (MEKO) blocked compound of reaction product between trimethylolpropane (TMP) and toluene diisocyanate (TDI))

First, a reaction product of trimethylolpropane and toluene diisocyanate was prepared: Polurene AD (75 mass % content of reaction product of trimethylolpropane and toluene diisocyanate (mass ratio of 2,4 isomer and 2,6 isomer: 80:20), solvent: ethyl acetate, trade name of SAPICI).

A 1 mol portion of the prepared reaction product of trimethylolpropane and toluene diisocyanate was heated to 60 to 70° C. Next, 3 mol of methyl ethyl ketoxime was slowly charged in, reaction was conducted at 60 to 70° C. until the isocyanate content reached zero as confirmed by an infrared spectrophotometer, and ethyl acetate was added to obtain a colorless transparent, viscous liquid composition containing 98.7 mass % of a methyl ethyl ketoxime-blocked polyisocyanate compound.

After mixing 180 parts by mass of the obtained composition with 20 parts by mass of a 30 mol ethylene oxide addition product of tristyrenated phenol as a nonionic surfactant, the mixture was homogenized. After gradually loading water while stirring, homogenizing treatment was carried out at 30 MPa to obtain a dispersion containing 40 mass % of a methyl ethyl ketoxime-blocked reaction product of trimethylolpropane and toluene diisocyanate.

### <Production of Acrylic Dispersion>

### [Materials]

### (Acrylic Monomer (a))

Stearyl acrylate: Osaka Organic Chemical Industry, Ltd.
Stearyl methacrylate: Tokyo Kasei Kogyo Co., Ltd,
Behenyl methacrylate: BASF Corp.

### (Acrylic Monomer (c))

Diacetoneacrylamide: Tokyo Kasei Kogyo Co., Ltd.

### (Acrylic Monomer (b))

Vinyl chloride: AGC

### (Nonionic Surfactant)

NOIGEN XL-40: Polyoxyalkylene branched decyl ether by Dai-ichi Kogyo Seiyaku Co., Ltd., HLB=10.5
NOIGEN XL-60: Polyoxyalkylene branched decyl ether by Dai-ichi Kogyo Seiyaku Co., Ltd., HLB=12.5
NOIGEN XL-100: Polyoxyalkylene branched decyl ether by Dai-ichi Kogyo Seiyaku Co, Ltd., HLB=14.7

### (Alkyl-Modified Silicone)

Silwax L118: Octadecyldimethicone by Siltech Corp.
Silwax D222: Behenyldimethicone by Siltech Corp.
Silwax J1032: C32 Alkyldimethicone by Siltech Corp.

### (Cationic Surfactant)

Stearyltrimethylammonium chloride: Lion Specialty Chemicals Co., Ltd

### (Organic Solvent)

Tripropylene glycol: Adeka Corp.

### (Polymerization Initiator)

Azobis(isobutylamidine) dihydrochloride: FujiFilm-Wako

### Production Example 20

After placing 15.6 g of stearyl acrylate, 0.4 g of diacetoneacrylamide, 0.8 g of NOIGEN XL-100, 0.2 g of stearyltrimethylammonium sulfate, 10 g of tripropylene glycol and 68.8 g of water in an autoclave, the components were mixed and stirred at 45° C. to obtain a mixture. The liquid mixture was irradiated with ultrasonic waves to emulsify and disperse the total monomers.

Next, 0.2 g of azobis(isobutylamidine) dihydrochloride was added to the dispersion, and 4.0 g of vinyl chloride was continuously injected under a nitrogen atmosphere to maintain an internal pressure of 03 MPa in the autoclave while conducting radical polymerization at 60° C. for 6 hours to obtain a dispersion containing 20 mass % of an acrylic resin.

### Production Examples 21 and 22

A dispersion containing 20 mass % of an acrylic resin was obtained by the same procedure as Production Example 20, using the charging amounts listed in Table 2.

### Production Example 23

After placing 13.6 g of stearyl acrylate, 0.4 g of diacetone acrylamide, 2.0 g of Silwax L118, 0.8 g of NOIGEN XL-1-00, 0.2 g of stearyltrimethylammonium sulfate, 10 g of tripropylene glycol and 68.8 g of water in an autoclave, the components were mixed and stirred at 45° C. to obtain a mixture. The liquid mixture was irradiated with ultrasonic waves to emulsify and disperse the total monomers.

Next, 0.2 g of azobis(isobutylamidine) dihydrochloride was added to the dispersion, and 4.0 g of vinyl chloride was continuously injected under a nitrogen atmosphere to maintain an internal pressure of 0.3 MPa in the autoclave while conducting radical polymerization at 60° C. for 6 hours to obtain a dispersion containing 20 mass % of an acrylic resin.

### Production Examples 24 and 25

A dispersion containing 20 mass % of an acrylic resin was obtained by the same procedure as Production Example 23, using the charging amounts listed in Table 2.

### <Production of Water-Repellent and Oil-Repellent Composition and Water-Repellent and Oil-Repellent Fiber Products>

The fiber products used were a dyed 100% polyester (PET) woven fabric and a dyed 100% nylon (Ny) woven fabric.

### Example 1

The silicone dispersion and crosslinking component dispersion 1 obtained in Production Example 1 were diluted with purified water to a silicone dispersion content of 5 mass % and a crosslinking component dispersion 1 content of 0.5 mass %, to produce a water-repellent and oil-repellent composition. Using the water-repellent and oil-repellent composition as the treatment solution, the dyed 100% polyester fabric and dyed 100% nylon fabric were each dipped in the treatment solution (pickup rate: 60 mass %), and then dried at 130° C. for 1 minute. Heat treatment was then carried out for 1 minute at 170° C. to obtain a water-repellent and oil-repellent fiber product.

### Examples 2 to 37, Comparative Examples 1 to 3

The same procedure was carried out as in Example 1, except that the silicone dispersion, acrylic dispersion and crosslinking component dispersion 1 were as shown in Tables 3 and 4.

### <Evaluation>

### [Amount of Water Necessary to Dissolve 1 g of Organic Solvent]

For the organic solvent used in each of the Production Examples, the amount of water necessary for dissolution of 1 g of the organic solvent was evaluated as the volume (mL) of water necessary for dissolution within 30 minutes, when 1 g of the organic solvent was placed in a fixed amount of water and vigorously agitated for 30 seconds every 5 minutes at 20° C. 15° C., according to JIS K8001:2017 3.2, “Terms for expressing dissolution”. For this measurement, 1 mL, 10 mL, 30 mL, 100 mL or 1000 mL of water was used as the fixed amount of water, and it was determined whether or not 1 g of organic solvent dissolved within 30 minutes under the conditions specified above, using the following evaluation scale.

### (Evaluation Scale for Amount of Water Necessary for Dissolution of 1 g of Organic Solvent)

≤1 mL: Dissolved within 30 minutes in 1 mL of water.
>1 mL and ≤10 mL: Not dissolved within 30 minutes in 1 mL of water, but dissolved within 30 minutes in 10 mL of water.
>10 mL and ≤30 mL: Not dissolved within 30 minutes in 10 mL of water, but dissolved within 30 minutes in 30 mL of water.
>30 mL and ≤100 mL: Not dissolved within 30 minutes in 30 mL of water, but dissolved within 30 minutes in 100 mL of water.
>100 mL and ≤1000 mL: Not dissolved within 30 minutes in 100 in of water, but dissolved within 30 minutes in 1000 mL of water.
>1000 mL: Not dissolved within 30 minutes in 1000 mL.

### [Product Stability of Water-Repellent and Oil-Repellent Composition]

The product stability of the water-repellent and oil-repellent composition was evaluated by centrifugal separation. A 100 g portion of the water-repellent and oil-repellent composition was weighed out into a 1 L centrifugal bottle and the bottle was capped prior to centrifugal separation at 20° C., 8000 rpm for 30 minutes. The supernatant liquid after centrifugal separation was transferred to a separate container and the mass was weighed. The sedimentation rate was calculated by the following formula.

Sedimentation rate(%)={(Mass of water-repellent and oil-repellent composition weighed out into centrifugal bottle)−(mass of supernatant liquid)}/100

A lower sedimentation rate results in more satisfactory product stability.

### [Processing Stability of Water-Repellent and Oil-Repellent Composition]

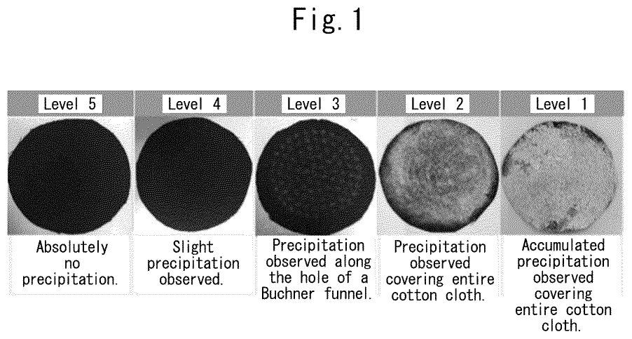

The processing stability of the water-repellent and oil-repellent composition was evaluated by a homomixer test. The water-repellent and oil-repellent composition was diluted to 5 mass % with purified water, and a homomixer (Model: T.K. Robomix D162 Homomixer MARKII by Primix Corp.) was used for stirring at 5000 rpm for 10 minutes at room temperature (25°), after which it was allowed to stand for 10 minutes. It was then filtered with black cotton cloth, and the state of the black cotton cloth was evaluated on a 5-level scale (see FIG. 1).
5: Absolutely no precipitation
4: Slight precipitation observed.
3: Precipitation observed along the hole of a Buchner funnel.
2: Precipitation observed covering entire cotton cloth.
1: Accumulated precipitation observed covering entire cotton cloth.

### [Water-Repellency of Water-Repellent and Oil-Repellent Fiber Products]

A water-repellent test was conducted according to the spray method of JIS L 1092(2009), with a shower water temperature of 20° C. The results were visually evaluated according to the following grade. When the properties were slightly satisfactory, “+” was added to the grade level, and when the properties were between grade 4 and grade 5, for example, the grade was indicated as “4-5”.

The evaluation scale for water-repellency was as follows.

### Water-Repellency: State

5: No adhesive wetting on front surface
4: Slight adhesive wetting on front surface
3: Partial wetting of front surface
2: Wetting of front surface
1: Wetting of entire front surface
0: Complete wetting of both front and back surfaces

### [Durable Water-Repellency of Water-Repellent and Oil-Repellent Fiber Product]

The water-repellent and oil-repellent fiber product was washed 10 times (L-10) by method 103 of JIS L 0217(1995), and the water-repellency after air-drying was evaluated in the same manner as the water-repellent evaluation method described above.

### [Texture of Water-Repellent and Oil-Repellent Fiber Product]

The water-repellent and oil-repellent fiber product was evaluated on the following 5-level scale by handling.

### 1: Hard to 5: Soft

Specifically, using the texture of the water-repellent and oil-repellent fiber product of Example 1 as the reference for level 1, and the texture of the water-repellent and oil-repellent fiber product of Example 4 as the reference for level 5, the textures of the water-repellent and oil-repellent fiber products of the other Examples and Comparative Examples were categorized on levels 1 to 5.

### [Evaluation of Seam Sliding Properties of Fiber Products]

The seam sliding resistance of the water-repellent and oil-repellent fiber products were measured by Method B of JIS L 1096:2010, 8.23 Sliding resistance: 8.23.1 Seam sliding method b). A smaller numerical value indicates a more excellent seam sliding property.

TABLE 1
Silicone dispersion

| | | Prod. | Prod. | Prod. | Prod. | Prod. | Prod. | Prod. | Prod. | Prod. | Prod. | Prod. |
|---|---|---|---|---|---|---|---|---|---|---|---|---|
| Content (parts by mass) | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
| Silicone | MQ-1600 | 250 | 240 | 240 | 100 | 90 | 90 | 190 | 90 | 90 | 90 | 100 |
| resin | | | | | | | | | | | | |
| Organic | Isoparaffin | 200 | 200 | 200 | 100 | 100 | 100 | 100 | 100 | 100 | 100 | 100 |
| solvent | Mineral oil | | | | | | | | | | | |
| | Mineral spirit | | | | | | | | | | | |
| A queous | Isopropanol | | | | | | | | | | | |
| medium | Tripropylene glycol | | | | | | | | | | | |
| Alkyl- | Dimethylsilicone 1 | | | | 150 | | | | | | | |
| poly- | viscosity: 5 os | | | | | | | | | | | |
| siloxane | Dimethylsilicone 2 | | | | | 150 | | | 150 | 150 | 150 | 140 |
| | viscosity: 100 cs | | | | | | | | | | | |
| | Dimethylsilicone 3 | | | | | | 150 | | | | | |
| | viscosity: 1,000 cs | | | | | | | | | | | |
| | Dimethylsilicone 4 | | | | | | | 50 | | | | |
| | viscosity: 10,000 cs | | | | | | | | | | | |
| Amino- | Double-terminated | | 10 | | | 10 | 10 | 10 | | | | |
| modified | monoamine functional | | | | | | | | | | | |
| silicone | group equivalents: 460 | | | | | | | | | | | |
| | BY16-853U | | | | | | | | | | | |
| | Side chain diamine I | | | | | | | | 10 | | | |
| | functional group | | | | | | | | | | | |
| | equivalents: 11,000 | | | | | | | | | | | |
| | KF-8005 | | | | | | | | | | | |
| | Side chain diamine 2 | | | 10 | | | | | | 10 | | |
| | functional group | | | | | | | | | | | |
| | equivalents: 1,800 | | | | | | | | | | | |
| | SF-8417 | | | | | | | | | | | |
| | Side chain diamine 3 | | | | | | | | | | 10 | |
| | functional group | | | | | | | | | | | |
| | equivalents: 350 | | | | | | | | | | | |
| | KF-393 | | | | | | | | | | | |
| | Side chain monoamine | | | | | | | | | | | 10 |
| | functional group | | | | | | | | | | | |
| | equivalents: 3,800 | | | | | | | | | | | |
| | KF-864 | | | | | | | | | | | |
| Nonionic | Polyoxyethylene(7 | 25 | 25 | 25 | 20 | 20 | 20 | 20 | 20 | 20 | 20 | 20 |
| surfactant | mol)isodecyl ether | | | | | | | | | | | |
| | Polyoxyethylene(9 | | | | 5 | 5 | 5 | 5 | 5 | 5 | 5 | 5 |
| | mol)isodecyl ether | | | | | | | | | | | |
| Cationic | LIPOGUARD T-28 | 5 | 5 | 5 | 5 | 5 | 5 | 5 | 5 | 5 | 5 | 5 |
| surfactant | | | | | | | | | | | | |

| | | | | | | | | | | | |
|---|---|---|---|---|---|---|---|---|---|---|---|
| Parts by mass silicone resin with | 125 | 120 | 120 | 100 | 90 | 90 | 190 | 90 | 90 | 90 | 100 |
| respect to 100 parts by mass | | | | | | | | | | | |
| organic solvent | | | | | | | | | | | |
| Parts by mass silicone resin with | — | 2400 | 2400 | — | 900 | 900 | 1900 | 900 | 900 | 900 | 1000 |
| respect to 100 parts by mass | | | | | | | | | | | |
| amino-modified silicone | | | | | | | | | | | |
| Parts by mass alkylpolysiloxane | — | 0 | 0 | — | 1500 | 1500 | 500 | 1500 | 1500 | 1500 | 1400 |
| with respect to 100 parts by mass | | | | | | | | | | | |
| amino-modified silicone | | | | | | | | | | | |
| Silicone resin:alkylpolysiloxane | — | — | — | 40:60 | 42:58 | 42:58 | 79:21 | 42:58 | 42:58 | 42:58 | 42:58 |
| mass ratio | | | | | | | | | | | |
| Silicone resin + | 250 | 250 | 250 | 250 | 250 | 250 | 250 | 250 | 250 | 250 | 250 |
| alkylpolysilicone + amino-modified | | | | | | | | | | | |
| silicone, total mass | | | | | | | | | | | |

| | | Prod. | Prod. | Prod. | Ex. 15 | Prod. | Prod. | Prod. | Prod. | Comp. | Comp |
|---|---|---|---|---|---|---|---|---|---|---|---|
| Content (parts by mass) | | Ex. 12 | Ex. 13 | Ex. 14 | Prod. | Ex. 16 | Ex. 17 | Ex. 18 | Ex. 19 | Prod. | Prod. |
| Silicone | MQ-1600 | 80 | 80 | 80 | 80 | 50 | 120 | 180 | 100 | 250 | 90 |
| resin | | | | | | | | | | | |
| Organic | Isoparaffin | 200 | | | | | | | 100 | | |
| solvent | Mineral oil | | 450 | 13 | 20 | | | | | | |
| | Mineral spirit | | | | | 100 | 100 | 100 | | | |
| A queous | Isopropanol | | | | | | | | | 200 | |
| medium | Tripropylene glycol | | | | | | | | | | 200 |
| Alkyl- | Dimethylsilicone 1 | | | | | | | | 110 | | 140 |
| poly- | viscosity: 5 os | | | | | | | | | | |
| siloxane | Dimethylsilicone 2 | 150 | 150 | 150 | 150 | 180 | 110 | 50 | | | |
| | viscosity: 100 cs | | | | | | | | | | |
| | Dimethylsilicone 3 | | | | | | | | | | |
| | viscosity: 1,000 cs | | | | | | | | | | |
| | Dimethylsilicone 4 | | | | | | | | | | |
| | viscosity: 10,000 cs | | | | | | | | | | |
| Amino- | Double-terminated | 20 | | | | 20 | 20 | 20 | | | 20 |
| modified | monoamine functional | | | | | | | | | | |
| silicone | group equivalents: 460 | | | | | | | | | | |
| | BY16-853U | | | | | | | | | | |
| | Side chain diamine I | | | | | | | | | | |
| | functional group | | | | | | | | | | |
| | equivalents: 11,000 | | | | | | | | | | |
| | KF-8005 | | | | | | | | | | |
| | Side chain diamine 2 | | 20 | 20 | 20 | | | | | | |
| | functional group | | | | | | | | | | |
| | equivalents: 1,800 | | | | | | | | | | |
| | SF-8417 | | | | | | | | | | |
| | Side chain diamine 3 | | | | | | | | 40 | | |
| | functional group | | | | | | | | | | |
| | equivalents: 350 | | | | | | | | | | |
| | KF-393 | | | | | | | | | | |
| | Side chain monoamine | | | | | | | | | | |
| | functional group | | | | | | | | | | |
| | equivalents: 3,800 | | | | | | | | | | |
| | KF-864 | | | | | | | | | | |
| Nonionic | Polyoxyethylene(7 | 20 | 20 | 20 | 20 | 20 | 20 | 20 | 20 | 20 | 20 |
| surfactant | mol)isodecyl ether | | | | | | | | | | |
| | Polyoxyethylene(9 | 5 | 5 | 5 | 5 | 5 | 5 | 5 | 5 | | 5 |
| | mol)isodecyl ether | | | | | | | | | | |
| Cationic | LIPOGUARD T-28 | 5 | 5 | 5 | 5 | 5 | 5 | 5 | 5 | 5 | 5 |

| | | | | | | | | | | |
|---|---|---|---|---|---|---|---|---|---|---|
| surfactant | | | | | | | | | | |
| Parts by mass silicone resin with | 40 | 18 | 615 | 400 | 50 | 120 | 180 | 100 | — | — |
| respect to 100 parts by mass | | | | | | | | | | |
| organic solvent | | | | | | | | | | |
| Parts by mass silicone resin with | 400 | 400 | 400 | 400 | 250 | 600 | 900 | 250 | — | 450 |
| respect to 100 parts by mass | | | | | | | | | | |
| amino-modified silicone | | | | | | | | | | |
| Parts by mass alkylpolysiloxane | 750 | 750 | 750 | 750 | 900 | 550 | 250 | 275 | — | 700 |
| with respect to 100 parts by mass | | | | | | | | | | |
| amino-modified silicone | | | | | | | | | | |
| Silicone resin:alkylpolysiloxane | 35:65 | 35:65 | 35:65 | 35:65 | 22:78 | 52:48 | 78:22 | 48:52 | | |
| mass ratio | | | | | | | | | | |
| Silicone resin + | 250 | 250 | 250 | 250 | 250 | 250 | 250 | 250 | 250 | 250 |
| alkylpolysilicone + amino-modified | | | | | | | | | | |
| silicone, total mass | | | | | | | | | | |

TABLE 2
Acrylic dispersion

| | | Prod. | Prod. | Prod. | Prod. | Prod. | Prod. |
|---|---|---|---|---|---|---|---|
| Content (mass %) | | Ex. 20 | Ex. 21 | Ex. 22 | Ex. 23 | Ex. 24 | Ex. 25 |
| Acrylic monomer (a) | Stearyl acrylate | 15.6 | 12 | 16 | 13.6 | 10 | 11.6 |
| | Stearyl methacrylate | | 3 | | | 2 | |
| | Behenyl methacrylate | | 2 | | | 1 | |
| Acrylic monomer (b) | Diacetone acrylamide | 0.4 | | | 0.4 | | 0.4 |
| Acrylic monomer (c) | Vinyl chloride | 4 | 3 | 4 | 4 | 3 | 2 |
| Nonionic surfactant | NOIGEN XL-40 | | | 0.8 | | | |
| | NOIGEN XL-60 | | 0.8 | | | 0.8 | |
| | NOIGEN XL-100 | 0.8 | | | 0.8 | | 0.8 |
| Alkyl-modified silicone | Silwax L118 | | | | 2 | | |
| | Silwax D222 | | | | | | 6 |
| | Silwax J1032 | | | | | 4 | |
| Cationic surfactant | Stearyltrimethylammonium sulfate | 0.2 | 0.2 | 0.2 | 0.2 | 0.2 | 0.2 |
| Aqueous medium | Tripropylene glycol | 10 | 10 | 10 | 10 | 10 | 10 |
| Polymerization initiator | Azobis(isobutylamidine)dihydrochloride | 0.2 | 0.2 | 0.2 | 0.2 | 0.2 | 0.2 |

| | | | | | | |
|---|---|---|---|---|---|---|
| Water | 68.8 | 68.8 | 68.8 | 68.8 | 68.8 | 68.8 |
| Total | 100 | 100 | 100 | 100 | 100 | 100 |

TABLE 3
Acrylic-non-combined system

| | | | | | | | | | | | | Ex. | Ex. | Ex. | Ex. | Ex. | Ex. | Ex. | Ex. | Ex. | Ex. | Comp. | Comp. |
|---|---|---|---|---|---|---|---|---|---|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | 10 | 11 | 12 | 13 | 14 | 15 | 16 | 17 | 18 | 19 | Ex. 1 | Ex. 2 |
| Content | Silicone amount | Prod. Ex. 1 | 5 | | | | | | | | | | | | | | | | | | | | |
| (mass %) | from silicone | Prod. Ex. 2 | | 5 | | | | | | | | | | | | | | | | | | | |
| | dispersion | Prod. Ex. 3 | | | 5 | | | | | | | | | | | | | | | | | | |
| | | Prod. Ex. 4 | | | | 5 | | | | | | | | | | | | | | | | | |
| | | Prod. Ex. 5 | | | | | 5 | | | | | | | | | | | | | | | | |
| | | Prod. Ex. 6 | | | | | | 5 | | | | | | | | | | | | | | | |
| | | Prod. Ex. 7 | | | | | | | 5 | | | | | | | | | | | | | | |
| | | Prod. Ex. 8 | | | | | | | | 5 | | | | | | | | | | | | | |
| | | Prod. Ex. 9 | | | | | | | | | 5 | | | | | | | | | | | | |
| | | Prod. Ex. 10 | | | | | | | | | | 5 | | | | | | | | | | | |
| | | Prod. Ex. 11 | | | | | | | | | | | 5 | | | | | | | | | | |
| | | Prod. Ex. 12 | | | | | | | | | | | | 5 | | | | | | | | | |
| | | Prod. Ex. 13 | | | | | | | | | | | | | 5 | | | | | | | | |
| | | Prod. Ex. 14 | | | | | | | | | | | | | | 5 | | | | | | | |
| | | Prod. Ex. 15 | | | | | | | | | | | | | | | 5 | | | | | | |
| | | Prod. Ex. 16 | | | | | | | | | | | | | | | | 5 | | | | | |
| | | Prod. Ex. 17 | | | | | | | | | | | | | | | | | 5 | | | | |
| | | Prod. Ex. 18 | | | | | | | | | | | | | | | | | | 5 | | | |
| | | Prod. Ex. 19 | | | | | | | | | | | | | | | | | | | 5 | | |
| | | Comp. Prod. | | | | | | | | | | | | | | | | | | | | 5 | |
| | | Ex. 1 | | | | | | | | | | | | | | | | | | | | | |
| | | Comp. Prod. | | | | | | | | | | | | | | | | | | | | | 5 |
| | | Ex. 2 | | | | | | | | | | | | | | | | | | | | | |
| | Polyfunctional | Crosslinking | 0.5 | 0.5 | 0.5 | 0.5 | 0.5 | | | 0.5 | 0.5 | 0.5 | 0.5 | 0.5 | 0.5 | 0.5 | 0.5 | 0.5 | 0.5 | 0.5 | 0.5 | 0.5 | 0.5 |
| | isocyanate | component | | | | | | | | | | | | | | | | | | | | | |
| | amount from | dispersion 1 | | | | | | | | | | | | | | | | | | | | | |
| | crosslinking | Crosslinking | | | | | | 1.0 | | | | | | | | | | | | | | | |
| | component | component | | | | | | | | | | | | | | | | | | | | | |
| | dispersion | dispersion 2 | | | | | | | | | | | | | | | | | | | | | |
| | | Crosslinking | | | | | | | 0.5 | | | | | | | | | | | | | | |
| | | component | | | | | | | | | | | | | | | | | | | | | |
| | | dispersion 3 | | | | | | | | | | | | | | | | | | | | | |
| Evaluation | Initial water- | 5 (good) → | 5 | 5 | 5 | 5 | 5 | 5 | 5 | 5 | 5 | 5 | 5 | 5 | 5 | 5 | 5 | 4 | 5 | 5 | 5 | 3 | 5 |
| | repellency (PET) | 1 (poor) | | | | | | | | | | | | | | | | | | | | | |
| | Initial water- | 5 (good) → | 5 | 5 | 5 | 5 | 5 | 5 | 5 | 5 | 5 | 5 | 5 | 5 | 5 | 5 | 5 | 4 | 5 | 5 | 5 | 3 | 5 |
| | repelleney (Ny) | 1 (poor) | | | | | | | | | | | | | | | | | | | | | |
| | Durable water- | 5 (good) → | 2 | 4 | 4 | 2 | 4 | 4 | 4 | 4 | 4 | 4 | 4 | 4 | 4 | 4 | 4 | 3 | 4 | 4 | 4 | 1 | 4 |
| | repellency | 1 (poor) | | | | | | | | | | | | | | | | | | | | | |
| | (HL-10) (PET) | | | | | | | | | | | | | | | | | | | | | | |
| | Durable water- | 5 (good) → | 2 | 4 | 4 | 2 | 4 | 4 | 4 | 4 | 4 | 4 | 4 | 4 | 4 | 4 | 4 | 3 | 4 | 4 | 4 | 1 | 4 |
| | repellency | 1 (poor) | | | | | | | | | | | | | | | | | | | | | |
| | (HL-10) (Ny) | | | | | | | | | | | | | | | | | | | | | | |
| | Texture (PET) | 5 (good) → | 1 | 2 | 2 | 5 | 5 | 5 | 4 | 5 | 5 | 5 | 5 | 5 | 5 | 5 | 5 | 5 | 5 | 4 | 5 | 1 | 5 |
| | | 1 (poor) | | | | | | | | | | | | | | | | | | | | | |
| | Seam sliding | | 1.0 | 1.8 | 1.9 | 1.2 | 1.8 | 1.8 | 1.8 | 2.5 | 1.9 | 1.8 | 1.9 | 1.8 | 1.9 | 1.9 | 1.9 | 1.8 | 1.8 | 1.8 | 1.8 | 1.0 | 1.8 |
| | resistance (mm) | | | | | | | | | | | | | | | | | | | | | | |
| | Product stability | Sedimentation | 2.3 | 2.5 | 2.1 | 2.2 | 2.3 | 2.5 | 2.8 | 2.5 | 2.5 | 2.2 | 1.9 | 2.0 | 8.2 | 10.1 | 5.5 | 2.4 | 2.5 | 2.6 | 2.1 | 20.5 | 18.5 |
| | | rate % | | | | | | | | | | | | | | | | | | | | | |
| | Processing | 5 (good) → | 5 | 5 | 5 | 5 | 5 | 5 | 5 | 5 | 5 | 5 | 5 | 5 | 3-4 | 3 | 4 | 5 | 5 | 5 | 5 | 1 | 1 |
| | stability | 1 (poor) | | | | | | | | | | | | | | | | | | | | | |

TABLE 4
Acrylic-combined system

| | | | Ex. | Ex. | Ex. | Ex. | Ex. | Ex. | Ex. | Ex. | Ex. | Ex. |
|---|---|---|---|---|---|---|---|---|---|---|---|---|
| | | | 20 | 21 | 22 | 23 | 24 | 25 | 26 | 27 | 28 | 29 |
| Content | Silicone amount | Prod. Ex. 5 | 2.5 | 2.5 | 2.5 | 2.5 | 2.5 | 2.5 | | | | |
| (mass %) | from silicone | Prod. Ex. 9 | | | | | | | 3.3 | 2.5 | 1.7 | 2.5 |
| | dispersion | Prod. Ex. 1 | | | | | | | | | | |
| | Acrylic resin | Prod. Ex. 20 | 2.5 | | | | | | | | | |
| | amount from | Prod. Ex. 21 | | 2.5 | | | | | | 2.5 | | |
| | acrylic dispersion | Prod. Ex. 22 | | | 2.5 | | | | | | 3.3 | |
| | | Prod. Ex. 23 | | | | 2.5 | | | | | | 2.5 |
| | | Prod. Ex. 24 | | | | | 2.5 | | | | | |
| | | Prod. Ex. 25 | | | | | | 2.5 | | | | |
| | Silicone amount | Comp. Prod. | | | | | | | | | | |
| | from comparison | Ex. 2 | | | | | | | | | | |
| | dispersion | Crosslinking | 0.5 | 0.5 | 0.5 | | | | 0.5 | | | 0.5 |
| | Polyfunctional | component | | | | | | | | | | |
| | isocyanate amount | dispersion 1 | | | | | | | | | | |
| | from crosslinking | Crosslinking | | | | 0.5 | | | | 0.5 | 0.5 | |
| | component | component | | | | | | | | | | |
| | dispersion | dispersion 3 | | | | | | | | | | |
| Evaluation | Initial water- | 5 (good) → 1 | 5 | 5 | 5 | 5 | 5 | 5 | 5 | 5 | 5 | 5 |
| | repellency (PET) | (poor) | | | | | | | | | | |
| | Initial water- | 5 (good) → 1 | 5 | 5 | 5 | 5 | 5 | 5 | 5 | 5 | 5 | 5 |
| | repellency (Ny) | (poor) | | | | | | | | | | |
| | Durable | 5 (good) → 1 | 4 | | 5 | 5 | 5 | 5 | 5 | 5 | 5 | 5 |
| | water-repellency | (poor) | | | | | | | | | | |
| | (HL-10) (PET) | | | | | | | | | | | |
| | Durable | 5 (good) → 1 | 4 | 4 | 5 | 5 | 5 | 5 | 5 | 5 | 5 | 5 |
| | water-repellency | (poor) | | | | | | | | | | |
| | (HL-10) (Ny) | | | | | | | | | | | |
| | Texture (PET) | 5 (good) → 1 | 3 | 3 | 3 | 4 | 4 | 3 | 4 | 3 | 2-3 | 3 |
| | Seam sliding | (poor) | 3.1 | 2.9 | 3.0 | 3.1 | 3.0 | 3.1 | 3.1 | 2.9 | 3.0 | 3.1 |
| | resistance (mm) | | | | | | | | | | | |
| | Product stability | Sedimentation | 2.3 | 2.6 | 2.3 | 2.5 | 2.5 | 2.7 | 2.6 | 2.4 | 2.2 | 2.3 |
| | | rate % | | | | | | | | | | |
| | Processing stability | 5 (good) → 1 | 5 | 5 | 5 | 5 | 5 | 5 | 5 | 5 | 5 | 5 |
| | | (poor) | | | | | | | | | | |

| | | | Ex. | Ex. | Ex | Ex. | Ex. | Ex. | Ex. | Ex. | Comp. |
|---|---|---|---|---|---|---|---|---|---|---|---|
| | | | 30 | 31 | 32 | 33 | 34 | 35 | 36 | 37 | Ex. 3 |
| Content | Silicone amount | Prod. Ex. 5 | | | | | | | | | |
| (mass %) | from silicone | Prod. Ex. 9 | 2.5 | 2.5 | | | | | | | |
| | dispersion | Prod. Ex. 1 | | | 2.5 | 2.5 | 2.5 | 2.5 | 2.5 | 2.5 | |
| | Acrylic resin | Prod. Ex. 20 | | | 2.5 | | | | | | |
| | amount from | Prod. Ex. 21 | | | | 2.5 | | | | | 2.5 |
| | acrylic dispersion | Prod. Ex. 22 | | | | | 2.5 | | | | |
| | | Prod. Ex. 23 | | | | | | 2.5 | | | |
| | | Prod. Ex. 24 | 2.5 | | | | | | 2.5 | | |
| | | Prod. Ex. 25 | | 2.5 | | | | | | 2.5 | |
| | Silicone amount | Comp. Prod. | | | | | | | | | 2.5 |
| | from comparison | Ex. 2 | | | | | | | | | |
| | dispersion | Crosslinking | | | 0.5 | 0.5 | 0.5 | | | | 0.5 |
| | Polyfunctional | component | | | | | | | | | |
| | isocyanate amount | dispersion 1 | | | | | | | | | |
| | from crosslinking | Crosslinking | | | | | | 0.5 | | | |
| | component | component | | | | | | | | | |
| | dispersion | dispersion 3 | | | | | | | | | |
| Evaluation | Initial water- | 5 (good) → 1 | 5 | 5 | | 5 | 5 | 5 | 5 | 5 | 5 |
| | repellency (PET) | (poor) | | | | | | | | | |
| | Initial water- | 5 (good) → 1 | 5 | 5 | 5 | 5 | 5 | 5 | 5 | 5 | 5 |
| | repellency (Ny) | (poor) | | | | | | | | | |
| | Durable | 5 (good) → 1 | 5 | 5 | 4 | 4 | 5 | 5 | 5 | 5 | 4 |
| | water-repellency | (poor) | | | | | | | | | |
| | (HL-10) (PET) | | | | | | | | | | |
| | Durable | 5 (good) → 1 | 5 | 5 | 4 | 4 | 5 | 5 | 5 | 5 | 4 |
| | water-repellency | (poor) | | | | | | | | | |
| | (HL-10) (Ny) | | | | | | | | | | |
| | Texture (PET) | 5 (good) → 1 | 4 | 4 | 2 | 2 | 2 | 3 | 3 | 2 | 3 |
| | Seam sliding | (poor) | 3.0 | 3.1 | 2.0 | 1.9 | 2.0 | 2.1 | 2.0 | 2.1 | 2.9 |
| | resistance (mm) | | | | | | | | | | |
| | Product stability | Sedimentation | 2.5 | 2.6 | 2.3 | 2.6 | 2.3 | 2.5 | 2.5 | 2.7 | 15.6 |
| | | rate % | | | | | | | | | |
| | Processing stability | 5 (good) → 1 | 5 | 5 | 5 | 5 | 5 | 5 | 5 | 5 | 2 |
| | | (poor) | | | | | | | | | |

### INDUSTRIAL APPLICABILITY

The water-repellent and oil-repellent composition of the invention has excellent product stability and processing stability, and is useful for production of water-repellent and oil-repellent products such as water-repellent and oil-repellent fiber products.

1-6. (canceled)

7. A water-repellent and oil-repellent composition comprising a silicone resin, an organic solvent, an emulsifier and an aqueous medium,
wherein the organic solvent is an organic solvent such that the amount of water necessary to dissolve 1 g of organic solvent at 20° C. is greater than 10 mL.

8. The water-repellent and oil-repellent composition according to claim 7, which further comprises an amino-modified silicone.

9. The water-repellent and oil-repellent composition according to claim 8, wherein the amino-modified silicone has a functional group equivalent of 100 to 20,000 g/mol.

10. The water-repellent and oil-repellent composition according to claim 7, which further comprises an alkylpolysiloxane.

11. The water-repellent and oil-repellent composition according to claim 8, which further comprises an alkylpolysiloxane.

12. The water-repellent and oil-repellent composition according to claim 7, which further comprises a polyfunctional isocyanate.

13. The water-repellent and oil-repellent composition according to claim 8, which further comprises a polyfunctional isocyanate.

14. The water-repellent and oil-repellent composition according to claim 10, which further comprises a polyfunctional isocyanate.

15. The water-repellent and oil-repellent composition according to claim 11, which further comprises a polyfunctional isocyanate.

16. A water-repellent and oil-repellent fiber product which is a fiber product treated by the water-repellent and oil-repellent composition according to claim 7.

17. The water-repellent and oil-repellent fiber product according to claim 16, wherein the water-repellent and oil-repellent composition further comprises an amino-modified silicone.

18. The water-repellent and oil-repellent fiber product according to claim 16, wherein the water-repellent and oil-repellent composition further comprises an alkylpolysiloxane.

19. The water-repellent and oil-repellent fiber product according to claim 16, wherein the water-repellent and oil-repellent composition further comprises a polyfunctional isocyanate.

20. A method for producing a water-repellent and oil-repellent fiber product, comprising a step of treating a fiber product with a treatment solution containing the water-repellent and oil-repellent composition according to claim 7.

21. The method according to claim 20, wherein the water-repellent and oil-repellent composition further comprises an amino-modified silicone.

22. The method according to claim 20, wherein the water-repellent and oil-repellent composition further comprises an alkylpolysiloxane.

23. The method according to claim 20, wherein the water-repellent and oil-repellent composition further comprises a polyfunctional isocyanate.
